(19) United States
(12) Patent Application Publication
(10) Pub. No.: US 2024/0078447 A1
(43) Pub. Date: Mar. 7, 2024

(54) SYSTEM AND METHOD FOR DETERMINING A SAMPLE RECOMMENDATION

(71) Applicant: Climax Foods Inc., Berkeley, CA (US)

(72) Inventors: Oliver Zahn, Berkeley, CA (US); Karthik Sekar, Berkeley, CA (US); Di Wei, Berkeley, CA (US); Sarah Hellmueller, Berkeley, CA (US); Daniel Westcott, Berkeley, CA (US); Itsi Weinstock, Berkeley, CA (US); Raphael Roccor, Berkeley, CA (US); Mia Shockley, Berkeley, CA (US)

(21) Appl. No.: 18/507,408

(22) Filed: Nov. 13, 2023

Related U.S. Application Data
(63) Continuation-in-part of application No. 18/202,174, filed on May 25, 2023.
Application No. 18/202,174 is a continuation of application No. 18/098,898, filed on Jan. 19, 2023, now Pat. No. 11,823,070.
(60) Provisional application No. 63/424,580, filed on Nov. 11, 2022.
(60) Provisional application No. 63/301,948, filed on Jan. 21, 2022.

(51) Int. Cl. G06N 5/022

(52) U.S. Cl. CPC G06N 5/022

(57) ABSTRACT

In variants, the method for determining a sample recommendation can include: determining characteristic values for a sample, determining target characteristic values, determining a similarity score for the sample based on the characteristic values for the sample and the target characteristic values, training a prediction model, and determining a sample recommendation.

### CROSS-REFERENCE TO RELATED APPLICATIONS

This application claims the benefit of U.S. Provisional Application No. 63/424,580 filed 11 Nov. 2022, which is incorporated in its entirety by this reference.

This application is a continuation-in-part of U.S. application Ser. No. 18/202,174 filed 25 May 2023, which is a continuation of U.S. application Ser. No. 18/098,898 filed 19 Jan. 2023, which claims the benefit of U.S. Provisional Application No. 63/301,948 filed 21 Jan. 2022, each of which is incorporated in its entirety by this reference.

### TECHNICAL FIELD

This invention relates generally to the food science field, and more specifically to a new and useful system and method in the food science field.

### BRIEF DESCRIPTION OF THE FIGURES

The patent or application file contains at least one drawing executed in color. Copies of this patent or patent application publication with color drawing(s) will be provided by the Office upon request and payment of the necessary fee

FIG. 1 is a schematic representation of a variant of the method.

FIG. 2 depicts an example of the method.

FIG. 3 depicts an example of a prediction model.

FIG. 4 depicts an example of aggregating similarity scores.

FIG. 5 depicts an illustrative example of determining a similarity score.

FIG. 6 depicts an illustrative example of a weight function.

FIG. 7 depicts an illustrative example of predicted similarity scores.

FIG. 8 depicts an example of determining a similarity score based on feature values.

FIG. 9 depicts an example of the method, including manufacturing a new prototype sample.

FIG. 10 depicts an example of differential scanning calorimetry (DSC) data for a control sample (e.g., an initial prototype sample; coconut:kokum 6.25:3.75 fat blend) and prototype samples (e.g., recommended samples) compared to DSC data for ghee (a target sample).

FIG. 11 depicts an example of DSC data for a dairy target, a prototype sample, and plant-based samples (e.g., for reference).

FIG. 12A depicts an example of 3 mm puncture assay data for prototype samples, a dairy sample, and plant-based samples (e.g., for reference) after 0 min at room temperature (from refrigeration at 4° C.).

FIG. 12B depicts an example of 3 mm puncture assay data for prototype samples, a dairy sample, and plant-based samples (e.g., for reference) after 30 min at room temperature (from refrigeration at 4° C.).

FIG. 12C depicts an example of 3 mm puncture assay data for prototype samples, a dairy sample, and plant-based samples (e.g., for reference) after 60 min at room temperature (from refrigeration at 4° C.).

FIG. 13 depicts an example of 3 mm puncture assay data for cheese samples manufactured using: ghee, a control fat blend (coconut:kokum 6.25:3.75 fat blend), and prototype fat blends.

FIG. 14 depicts an example of 3 mm puncture assay data (after 2 hours at room temperature from refrigeration at 4° C.) for: prototype cheese samples, control samples, dairy cheeses, and plant-based cheese samples.

FIG. 15A depicts an example of 3 mm puncture assay data for 3-week ripened cheese samples manufactured using: a control fat blend (coconut:kokum 6.25:3.75 fat blend), ghee, palm oil, and prototype fat blends.

FIG. 15B depicts an example of 3 mm puncture assay data for 6-week ripened cheese samples manufactured using: a control fat blend (coconut:kokum 6.25:3.75 fat blend), ghee, palm oil, and prototype fat blends.

FIG. 16A depicts an example of panelist texture ranking data for 3-week ripened cheese samples manufactured using: a control fat blend (coconut:kokum 6.25:3.75 fat blend) and prototype fat blends.

FIG. 16B depicts an example of panelist texture ranking data for 6-week ripened cheese samples manufactured using: a control fat blend (coconut:kokum 6.25:3.75 fat blend), ghee, palm oil, and prototype fat blends.

FIG. 17A depicts an example of panelist flavor ranking data for 3-week ripened cheese samples manufactured using: a control fat blend (coconut:kokum 6.25:3.75 fat blend) and prototype fat blends.

FIG. 17B depicts an example of panelist flavor ranking data for 6-week ripened cheese samples manufactured using: a control fat blend (coconut:kokum 6.25:3.75 fat blend), ghee, palm oil, and prototype fat blends.

FIG. 18A depicts example heat flow signals for a ghee sample and prototype samples, measured using DSC.

FIG. 18B depicts example firmness values for a ghee sample and prototype samples.

FIG. 19 depicts example heat flow signals for a sample, measured using DSC.

FIG. 20A depicts an example heat flow signal for a prototype sample.

FIG. 20B depicts an example heat flow signal for a prototype sample after 4 hr undergoing interesterification (e.g., catalyzed by Lipozyme TL IM at 55° C. reaction temperature).

FIG. 20C depicts an example heat flow signal for a prototype sample after 24 hr undergoing interesterification (e.g., catalyzed by Lipozyme TL IM at 55° C. reaction temperature).

FIG. 20D depicts an example of correlating firmness and average crystalline fraction (e.g., determined using heat flow signals in FIGS. 20A-20C).

FIG. 21 depicts an example of correlating firmness and solid fat content for samples.

FIGS. 22A and 22B depict examples of correlating saturated fatty acid composition and solid fat content for samples.

FIG. 23 depicts an example of calculating solid fat content.

FIGS. 24A and 24B depict an example of heat flow signals determined using temperature modulated DSC.

FIG. 25A depicts an example of characteristic values—including heat flow signals and feature values thereof—for a prototype sample.

FIG. 25B depicts an example of characteristic values—including heat flow signals and feature values thereof—for a target sample (e.g., ghee).

### DETAILED DESCRIPTION

The following description of the embodiments of the invention is not intended to limit the invention to these embodiments, but rather to enable any person skilled in the art to make and use this invention.

### 1. Overview

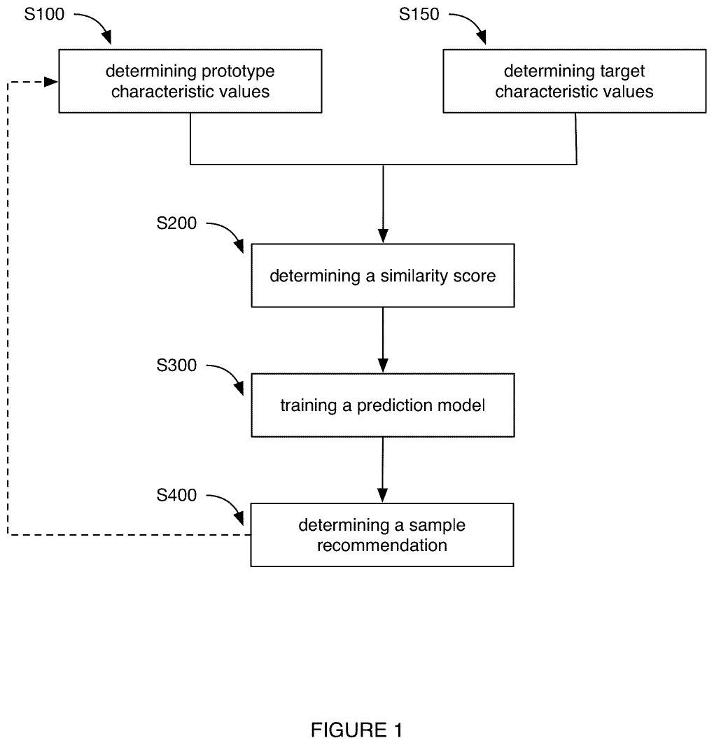

As shown in FIG. 1, the method can include: determining prototype characteristic values S100, determining target characteristic values S150, determining a similarity score S200, training a prediction model S300, and determining a sample recommendation S400. However, the method can additionally or alternatively include any other suitable steps.

In variants, the method can function to determine a sample composition (e.g., ingredients and proportions for each ingredient) and/or other process parameters for manufacturing a sample with target characteristic values. Additionally or alternatively, the method can function to select the next sample composition for training data collection, wherein the training data is used to train a prediction model to evaluate a sample.

### 2. EXAMPLES

In an example, the method can include: manufacturing a prototype sample according to a composition vector for the prototype sample (e.g., a proportion or concentration for each of a set of ingredients of interest in the prototype sample); performing one or more assays on the prototype sample to measure prototype characteristic values; and comparing the prototype characteristic values to target characteristic values (e.g., measured for a target sample) to determine a similarity score for the prototype sample. In a specific example, the target sample can include one or more dairy lipids and the prototype sample can include a blend of plant-based lipids, wherein the composition vector for the prototype sample can include a proportion of each plant-based lipid. In examples, characteristic values can include: a heat flow signal (e.g., a reversing heat flow signal, a total heat flow signal), solid fat content for one or more temperatures of interest (e.g., extracted from a reversing heat flow signal), a slope of the solid fat content over a temperature range of interest (e.g., which can be associated with mouthfeel and/or melt kinetics), firmness (e.g., extracted from a texture signal), saturated fatty acid composition, a combination thereof, and/or any other characteristic values. In a first example, determining the similarity score can include taking a difference between a prototype heat flow signal (e.g., reversing heat flow signal) and a target heat flow signal, processing the difference (e.g., squaring the difference), weighting the (processed) difference according to a temperature weight function, and determining the similarity score based on the weighted difference. In a second example, determining the similarity score can include taking a difference between a prototype characteristic value (e.g., firmness value, solid fat content, etc.) and a target characteristic value, and determining the similarity score based on the difference. The similarity score can optionally be an aggregate similarity score combining multiple similarity scores (e.g., a firmness similarity score, a heat flow signal similarity score, a solid fat content similarity score, etc.). In an example, a prediction model can be trained to output the similarity score based on the composition vector for the associated prototype sample. In a specific example, the prediction model can be trained using Bayesian optimization methods, wherein the prediction model can be a surrogate model approximating an objective function. The prediction model can optionally be used to determine a recommended sample composition (e.g., using an acquisition function), wherein the recommended sample composition can be used to manufacture a new prototype sample for additional training data collection and/or to manufacture a new prototype sample functioning as an analog for a target sample (e.g., an analog for a dairy food product).

### 3. TECHNICAL ADVANTAGES

Variants of the technology can confer one or more advantages over conventional technologies.

First, characteristic values (e.g., functional property values) for a sample are influenced by complex interactions between the sample ingredients, which makes predicting the characteristic values extremely challenging and computationally intensive. Additionally, experiments to measure the characteristic values for different samples can be cumbersome and time-consuming given the large number of possible ingredients, manufacturing parameters, and other sample variables. Variants of the technology can generate a high-accuracy prediction model in a low data regime by identifying optimal sample compositions to test for training data collection, resulting in fewer experiments needed to train the prediction model.

Second, variants of the technology can identify a sample composition (e.g., including ingredients and proportions for each ingredient) and/or process parameters for manufacturing a sample with target characteristic values. In an example, variants of the technology can identify a mixture of plant-based fats with a melt profile matching a melt profile of a target dairy fat, wherein the mixture can be used to manufacture a plant-based analog for a dairy food product.

Third, variants of the technology can use intermediate products to collect measurements for model training, wherein the trained model can be used to identify a recommended composition and/or process parameters for a final product. This can increase the efficiency of model training. For example, variants of the method can train a prediction model using: unfermented cheeses, products with a subset of ingredients (e.g., only fats, only fats and stabilizers, etc.), miniature cheeses, and/or any other intermediate products. The prediction model can then be used to identify a recommended composition (e.g., for all or a subset of ingredients in a final product) and/or process parameters for manufacturing a final product. For example, the intermediate product(s) can be compared to target(s) for model training using functional property measurements, and the final product(s) can be compared to target(s) using sensory panels.

Fourth, evaluating substance analogs (e.g., food replicates) is difficult. The conventional method of sensory panels is impractical and inaccurate (because the results can be subjective), difficult to normalize, and noisy. Furthermore, sensory panels are practically inefficient to run, especially when testing a large number of food prototypes. The inventors have discovered that measurements (e.g., functional property signals) can be weighted using a temperature weight function to more accurately represent the subjective (sensory) adjacency of a prototype to a target food and/or represent a proxy for the subjective (sensory) adjacency of a prototype to a target food. In a specific example, the temperature weight function can upweight the melt profile (e.g., heat flow signal) for a sample within a temperature range of interest (e.g., 20°-40° C., 30°-40° C., etc.) to capture room temperature stability, melt-in-the-mouth characteristics, proxies thereof and/or other temperature-dependent characteristics.

However, further advantages can be provided by the system and method disclosed herein.

### 4. METHOD

As shown in FIG. 1, the method can include: determining prototype characteristic values S100, determining target characteristic values S150, determining a similarity score S200, training a prediction model S300, and determining a sample recommendation S400.

All or portions of the method can be performed in real time (e.g., responsive to a request), iteratively, concurrently, asynchronously, periodically, and/or at any other suitable time. All or portions of the method can be performed automatically, manually, semi-automatically, and/or otherwise performed. All or portions of the method can be performed iteratively (e.g., until a stop condition is met), once, and/or any other number of times.

All or portions of the method can be performed using a computing system, using a database (e.g., a system database, a third-party database, etc.), by a user, using one or more assays and/or assay tools, and/or by any other suitable system. The computing system can include one or more: CPUs, GPUs, custom FPGA/ASICS, microprocessors, servers, cloud computing, and/or any other suitable components. The computing system can be local, remote, distributed, or otherwise arranged relative to any other system or module.

In examples, all or portions of the method can use systems and/or methods disclosed in U.S. application Ser. No. 18/202,174 filed 25 May 2023 and/or U.S. application Ser. No. 18/220,110 filed 10 Jul. 2023, each of which are incorporated herein in its entirety by this reference. However, all or portions of the method can be otherwise performed.

The method can be used with one or more samples. The sample can be a product (e.g., end-stage product, intermediate product, byproduct, etc.) and/or be used to manufacture a product. In examples, the sample can be a food product, material (e.g., leather, cloth, steel, etc.), gel, headspace, solution, mixture, component(s), ingredient(s), and/or any other substance. Examples of intermediate products include: a product that has undergone no or partial processing (e.g., an unfermented and/or unripened cheese) relative to an end-stage product (e.g., a fermented and/or ripened cheese), a product containing a subset of ingredients (e.g., only lipids, only lipids and stabilizers, etc.) relative to an end-stage product (e.g., cheese), a product that is a smaller scale relative to an end-stage product, and/or any other intermediate product. The sample can be solid, liquid, gas, a combination thereof, and/or be any other state of matter.

The sample can include one or more ingredients. Examples of ingredients include: plant matter, proteins (e.g., protein isolates), lipids (e.g., fats, oils, etc.), an aqueous component (e.g., water, a sucrose solution, etc.), preservatives, acids and/or bases, macronutrients (e.g., protein, lipids, starch, sugar, etc.), nutrients, micronutrients, carbohydrates (e.g., sugars, starches, fibers, polysaccharides, such as maltodextrin, gums, etc.), starches (e.g., native and/or modified starches; potato, tapioca, corn, sago, starch-based texturizers such as Advanta Gel S™, etc.), vitamins, enzymes (e.g., transglutaminase, chymosin, tyrosinase, laccase, bromelain, papain, ficain, other cysteine endopeptidases, rennet enzymes and/or rennet-type enzymes, etc.), emulsifiers (e.g., lecithin, glycerol monostearate, etc.), particulates, thickening agents, gelling agents, emulsifying agents, stabilizers, hydrocolloids (e.g., starch, gelatin, pectin, and gums, such as: agar, alginic acid, sodium alginate, guar gum, Ticaloid gum, locust bean gum, beta-glucan, xanthan gum, konjac gum, etc.), salts (e.g., NaCl, CaCl₂), NaOH, KCl, NaI, MgCl₂, etc.), minerals (e.g., calcium), chemical crosslinkers (e.g., transglutaminase and/or laccase) and/or non-crosslinkers (e.g., L-cysteine), coloring, flavoring compounds, vinegar (e.g., white vinegar), mold powders, microbial cultures, carbon sources (e.g., to supplement fermentation), calcium citrate, any combination thereof, and/or any other ingredient. Examples of microbial cultures that can be used include: cheese cultures (e.g., cheese starter cultures), yogurt cultures, wine cultures, beer cultures, and/or any other microbial culture and/or combination thereof. The ingredients can optionally exclude and/or include less than a threshold amount (e.g., 10%, 5%, 3%, 2%, 1%, 0.5%, 0.1%, etc.) of added: animal products, animal-derived ingredients, gums (e.g., polysaccharide thickeners), hydrocolloids, allergens, phospholipids, soy derivatives, starches, a combination thereof, and/or any other suitable ingredient. The ingredients are preferably food-safe, but can alternatively be not food-safe. The ingredients can be whole ingredients (e.g., include processed plant material), ingredients derived from plant-based sources, ingredients derived from plant genes, synthetic ingredients, and/or be any other ingredient. The ingredients can be processed (e.g., lipid-removal, mechanical processing, chemical processing, extracted, fermented, protein modifications, lipid modifications, etc.) and/or unprocessed.

For example, the sample can include one or more lipids (e.g., a mixture of lipids). Lipids can be derived from one or more plant sources (e.g., for prototype samples) and/or can be derived from animal sources (e.g., for target samples; dairy butter, lard, tallow, insect fats, etc.) and/or any other source. A lipid is preferably a triglyceride, but can additionally or alternatively be or include a monoglyceride, diglyceride, free fatty acids, phospholipid, and/or any other lipid. Lipids can be saturated, unsaturated (e.g., monounsaturated, polyunsaturated, etc.), branched, and/or have any other classification. Lipids (e.g., oils, fats, butter, etc.) can be liquid at a target temperature (e.g., room temperature), solid at a target temperature, and/or be any other state of matter. Examples of lipids include fats and/or oils derived from: avocado, mustard, coconut, palm (e.g., palm fruit, palm kernel, palm fruit stearin, palm shortening, palm olein, etc.), peanut, canola, cocoa, grapeseed, olive, rice bran, safflower, sesame, sunflower, soybean, pumpkin (e.g., pumpkin seed), kokum, shea, mango, hemp, vegetable, any neutral lipid, a synthetic lipid, any combination thereof, no or less than a threshold percentage of a lipid type (e.g., canola lipids), and/or any other lipid. The ingredients may include a combination of lipids (e.g., a blend). In a first example, a blend of lipids that are solid at room temperature (e.g., fats) and lipids that are liquid at room temperature (e.g., oils) can be used. In a second example a blend of different varieties of plant-based lipids, a blend of different varieties of animal-based lipids, and/or a blend of plant- and animal-based lipids may be used. Lipids can optionally be modified (e.g., interesterification, refining, clarifying, fractionating, adjusting saturation, adjusting lipid crystalline structure, adjusting chain length, adjusting melt point, adjusting smoke point, glycerolysis, etc.). In a specific example, Lipid interesterification can be catalyzed using Lipozyme TL IM.

In variants, samples can include prototype samples (e.g., test samples), target samples, and/or other substances.

A prototype sample is preferably a sample that is intended to mimic a target sample (e.g., partially or in its entirety) and/or intended for training data collection, but can alternatively be any other sample. For example, the prototype sample can have and/or be intended to have one or more characteristic values (e.g., functional property signals, functional property values, functional property feature values, other characteristic values, etc.) substantially similar to (e.g., within a predetermined margin of error, such as 1%, 5%, 10%, 20%, 30%, etc.) target characteristic values (e.g., for a target sample). For example, the prototype sample can be: a food analog or replicate (e.g., plant-based dairy analog), a material analog (e.g., plant-based leather), and/or any other substance. In a specific example the prototype sample can include one or more plant-based lipids (e.g., with no or less than a threshold percentage of dairy lipids), and the target sample can include one or more dairy lipids. However, the prototype sample can be otherwise defined.

In an example, a prototype sample can be: a replacement (e.g., analog) for a target food product (e.g., the prototype sample can be a plant-based analog for an animal food product), used to manufacture a target food product, a food product with one or more target characteristic values, and/or any other food product. The prototype sample can be a vegan product, a food product without animal products and/or with less animal products (e.g., relative to a target animal product), a plant-based food product, a microbial-based food product, a nonmammalian-based food product, and/or any other food product. Examples of target food products include: dairy lipids (e.g., ghee, other bovine milk lipids, etc.), milk, curds, cheese (e.g., hard cheese, soft cheese, semi-hard cheese, semi-soft cheese, fermented cheese, aged/ripened cheese, etc.), butter, yogurt, cream cheese, dried milk powder, cream, whipped cream, ice cream, coffee cream, other dairy products, egg products (e.g., scrambled eggs), additive ingredients, mammalian meat products (e.g., ground meat, steaks, chops, bones, deli meats, sausages, etc.), fish meat products (e.g., fish steaks, filets, etc.), any animal product, and/or any other suitable food product. In specific examples, the target food product includes mozzarella, burrata, feta, brie, ricotta, camembert, chevre, cottage cheese, cheddar, parmigiano, pecorino, gruyere, edam, gouda, jarlsberg, and/or any other cheese. In a specific example, the prototype sample can be or include an analog for a dairy lipid (e.g., ghee).

The prototype sample is preferably entirely plant matter, but can additionally or alternatively be primarily plant matter (e.g., more than 50%, 60%, 70%, 80%, 90%, 95%, 98%, 99%, etc.), partially plant matter, and/or have any other suitable plant matter content. The prototype can optionally exclude and/or include less than a threshold amount of total and/or added: animal products (e.g., excludes animal proteins, such as caseins), gums (e.g., polysaccharide thickeners), allergenic ingredients (e.g., soy, peanut, wheat, etc.), and/or any other suitable ingredient. Added ingredients and/or compounds can include: materials that were not present in and/or are foreign to a plant substrate or other ingredients, materials added in as a separate ingredient, and/or otherwise other components. The threshold amount can be between 0.1%-50% or any range or value therebetween (e.g., 40%, 30%, 10%, 5%, 3%, 2%, 1%, 0.1%, etc.), but can alternatively be greater than 50% or less than 0.1%.

The sample (e.g., prototype sample, target sample, etc.) can optionally be manufactured according to a set of process parameters (e.g., manufacturing variable values). Process parameters can define: manufacturing specifications; amounts thereof (e.g., ratios, volume, concentration, mass, etc.); temporal parameters thereof (e.g., when the input should be applied, duration of input application, etc.); and/or any other suitable manufacturing parameter. Manufacturing specifications can include: ingredients, treatments, and/or any other sample manufacturing input, wherein the process parameters can include parameters for each specification. Examples of treatments can include: adjusting temperature, adjusting salt level, adjusting pH level, diluting, pressurizing, depressurizing, humidifying, dehumidifying, agitating, resting, adding ingredients, removing components (e.g., filtering, draining, centrifugation, etc.), adjusting oxygen level, brining, comminuting, fermenting, aging (e.g., ripening), mixing (e.g., homogenizing), gelling (e.g., curdling), and/or other treatments. Examples of treatment parameters can include: treatment type, treatment duration, treatment rate (e.g., flow rate, agitation rate, cooling rate, rotor stator rpm, etc.), treatment temperature, time (e.g., when a treatment is applied, when the sample is characterized, etc.), and/or any other parameters. In a first example, manufacturing a sample can include mixing (e.g., homogenizing) the lipids and/or other ingredients based on a specified sample composition (e.g., proportions and/or concentrations for ingredients). In a second example, manufacturing a sample can include: forming a mixture of lipids and/or other ingredients (e.g., to produce a first intermediate product), adding additional ingredients to the mixture (e.g., to produce a second intermediate product), and fermenting and/or aging the sample (e.g., to produce an end-stage product such as a cheese or other dairy analog food product). In a specific example, prototype samples used for training data collection can be intermediate products (e.g., unfermented samples, unrepented samples, samples manufactured with a subset of end-stage product ingredients, etc.), and a prototype sample used as an analog for a target sample can be an end-stage product (e.g., fermented samples, ripened samples, etc.).

The sample can optionally be associated with (e.g., defined by) a sample vector. The sample vector can be based on a composition of all or parts of the sample, other process parameters for manufacturing the sample (e.g., lipid modifications for each of a set of lipids), and/or any other information associated with the sample. In a specific example, the composition of the sample can include proportions and/or concentrations for each lipid of a set of lipids (e.g., plant-based lipids) in the sample. For example, the sample vector can include process parameters (e.g., manufacturing variable values), wherein the sample can be manufactured given the sample vector (e.g., to match the composition as defined by the sample vector, manufactured according to other process parameters in the sample vector, etc.). In a specific example, the sample vector can include a vectorized lipid composition for the sample (e.g., for multiple plant-based lipids). The sample can optionally be associated with a cost (e.g., a cost to manufacture the sample based on the sample composition), wherein the cost can be included in the sample vector or not included in the sample vector. All or portions of sample vector values can be predetermined, predicted, measured, extracted from measurements, determined using a model, and/or otherwise determined.

In a first variant, a vector index of the sample vector represents an ingredient and/or process parameter (e.g., a manufacturing variable such as a specific lipid, a manufacturing step, etc.); and a vector index value (e.g., manufacturing variable value) represents an ingredient proportion (e.g., relative to one or more other ingredients; percent by weight, percent by mass, percent by mol, etc.), an ingredient concentration (e.g., absolute concentration), an ingredient amount (e.g., weight, mass, etc.), a process parameter value (e.g., an rpm value for rotor stator homogenization), and/or any other sample information. In a first illustrative example, a sample vector of [0.25, 0, 0.25, 0.5, 0, 0] would represent a sample with 25% coconut oil, 0% kokum butter, 25% palm fruit oil, 50% palm fruit shortening, 0% palm fruit stearin, and 0% glyceryl monostearate. In a second illustrative example, a sample vector of [0.3, 0.2, 0.5, 10000, 0.5, 0.5, 0] would represent a sample with 30% lipid component, 20% protein component, 50% liquid component (e.g., water, sucrose solution, etc.), homogenized at 10,000 rpm, wherein the lipid component is 50% coconut oil, 50% kokum butter, and 0% palm fruit oil. In a second variant, a vector index of the sample vector represents a macronutrient class (e.g., lipid), and a vector index value represents an ingredient for that macronutrient class (e.g., palm fruit oil).

However, the sample vector can be otherwise configured.

However, samples can be otherwise defined.

Determining prototype characteristic values S100 functions to quantify characteristics of a prototype. Prototype characteristic values preferably include characteristic values for a physical prototype sample, but can alternatively include characteristic values for a hypothetical prototype and/or other characteristic values. S100 can be performed after manufacturing the prototype sample and/or at any other time.

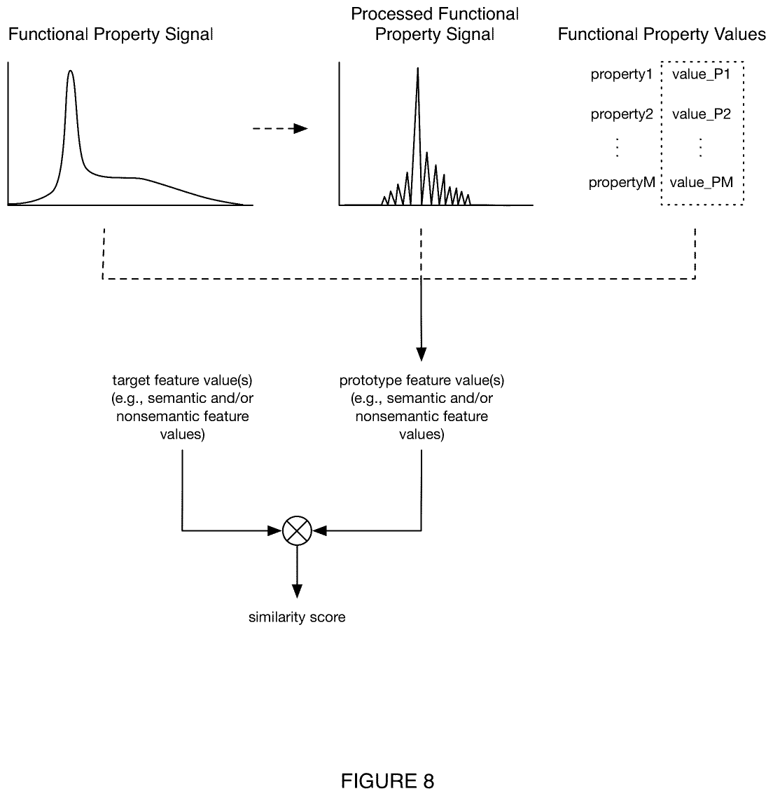

Characteristic values (e.g., functional property values, functional property signal, etc.) can be determined experimentally (e.g., using an assay tool), determined via computer simulations, retrieved from a database, predicted (e.g., predicted using a prediction model, predicted based other characteristic values, etc.), and/or otherwise determined. Experimentally determined characteristic values can be directly measured, determined based on analyzed and/or processed data, semantic and/or non-semantic features extracted from data, and/or otherwise determined. In a specific example of predicted characteristic values, a first set of characteristic values are experimentally determined, and a second set of characteristic values are predicted based on the first set (e.g., wherein characteristic values in the first and/or second sets can be used in all or parts of the method). In examples, a characteristic value can include: an individual value for a characteristic (e.g., functional property value), a set of values for a characteristic (e.g., a data time series, functional property signal, a processed functional property signal, etc.), a feature value extracted from one or more characteristic values (e.g., a feature value extracted from a functional property signal), and/or any other value for one or more characteristics. An example is shown in FIG. 8. Characteristic values can optionally be processed, wherein the processed characteristic values can be used as characteristic values in all or parts of the method. In examples, processing characteristic values can include: smoothing, transforming (e.g., squaring, transforming between domains, etc.), segmenting, normalizing, downsampling, aggregating (e.g., aggregating multiple characteristic values), integrating, differentiating, weighting, a combination thereof, and/or any other processing methods. In a specific example, processed characteristic values (e.g., a processed functional property signal) can include combined characteristic values (e.g., a combined functional property signal) and/or weighted characteristic values (e.g., a weighted functional property signal).

Characteristics (e.g., functional properties) can include: nutritional profile (e.g., macronutrient profile, micronutrient profile, etc.), nutritional quality (e.g., PDCAAS score), texture (e.g., texture profile, firmness, toughness, puncture, stretch, compression response, mouthfeel, viscosity, graininess, relaxation, stickiness, chalkiness, flouriness, astringency, crumbliness, stickiness, stretchiness, tear resistance/strength, mouth melt, shreddability, grateability, etc.), melt kinetics, solubility, melt profile, smoke profile, gelation point, flavor, appearance (e.g., color), aroma, precipitation, stability (e.g., room temperature stability), emulsion stability, ion binding capacity, heat capacity, solid fat content, chemical properties (e.g., pH, affinity, surface charge, isoelectric point, hydrophobicity/hydrophilicity, free sulfhydryl group content, chain lengths, chemical composition, nitrogen levels, chirality, stereospecific position, etc.), physiochemical properties, compound concentration (e.g., in the solid sample fraction, vial headspace, olfactory bulb, post-gustation, etc.), denaturation point, denaturation behavior, aggregation point, aggregation behavior (e.g., micellization capability, micelle stability, etc.), particle size, structure (e.g., microstructure, macrostructure, fat crystalline structure, etc.), folding state, folding kinetics, interactions with other molecules (e.g., dextrinization, caramelization, coagulation, shortening, interactions between lipid and protein, interactions with water, aggregation, micellization, etc.), lipid leakage, water holding and/or binding capacity, lipid holding and/or binding capacity, fatty acid composition (e.g., percent saturated/unsaturated lipids), moisture level, turbidity, properties determined using an assay tool, proxies thereof, and/or any other properties. Characteristic values can optionally include an uncertainty parameter (e.g., measurement uncertainty, determined using statistical analysis, etc.).

Examples of assays and/or assay tools that can be used include: a differential scanning calorimeter (e.g., to determine properties related to melt, gelation point, denaturation point, etc.), Schreiber Test, an oven (e.g., for the Schreiber Test), a water bath, a texture analyzer, a rheometer, spectrophotometer (e.g., determine properties related to color), centrifuge (e.g., to determine properties related to water binding capacity), moisture analyzer (e.g., to determine properties related to water availability), light microscope (e.g., to determine properties related to microstructure), atomic force microscope (e.g., to determine properties related to microstructure), confocal microscope (e.g., to determine protein association with lipid/water), laser diffraction particle size analyzer (e.g., to determine properties related to emulsion stability), polyacrylamide gel electrophoresis system (e.g., to determine properties related to protein composition), mass spectrometry (MS), time-of-flight mass spectrometry (TOF-MS), gas chromatography (GC) (e.g., gas chromatography-olfactometry, GC-MS, etc.; to determine properties related to aroma/flavor, to determine properties related to protein composition, etc.), selected ion flow tube mass spectrometry (SIFT-MS), liquid chromatography (LC), LC-MS, fast protein LC (e.g., to determine properties related to protein composition), protein concentration assay systems, thermal gravimetric analysis system, thermal shift (e.g., to determine protein denaturation and/or aggregation behavior), ion chromatography, dynamic light scattering system (e.g., to determine properties related to particle size, to determine protein aggregation, etc.), Zetasizer (e.g., to determine properties related to surface charge), protein concentration assays (e.g., Q-bit, Bradford, Biuret, Lecco, etc.), particle size analyzer, sensory panels (e.g., to determine properties related to texture, flavor, appearance, aroma, etc.), capillary electrophoresis SDS (e.g., to determine protein concentration), spectroscopy (e.g., fluorescence spectroscopy, circular dichroism, etc.; to determine folding state, folding kinetics, denaturation temperature, etc.), absorbance spectroscopy (e.g., to determine protein hydrophobicity), CE-IEF (e.g., to determine protein isoelectric point/charge), total protein quantification, high temperature gelation, microbial cloning, Turbiscan, stereospecific analysis, olfactometers, electrophysiological testing (e.g., of a human olfactometer), psychophysical testing (e.g., of a human olfactometer), and/or any other assay and/or assay tool.

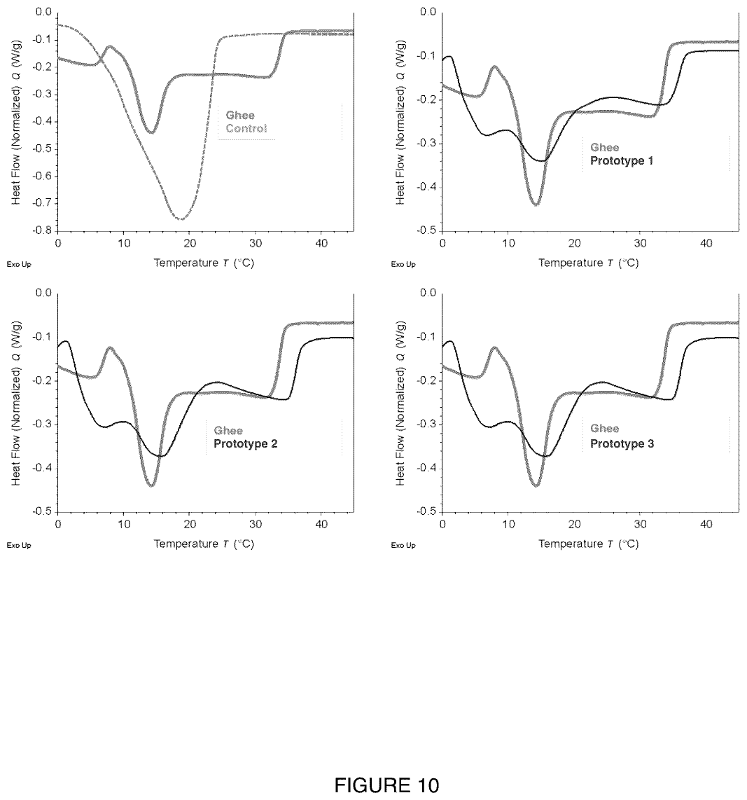

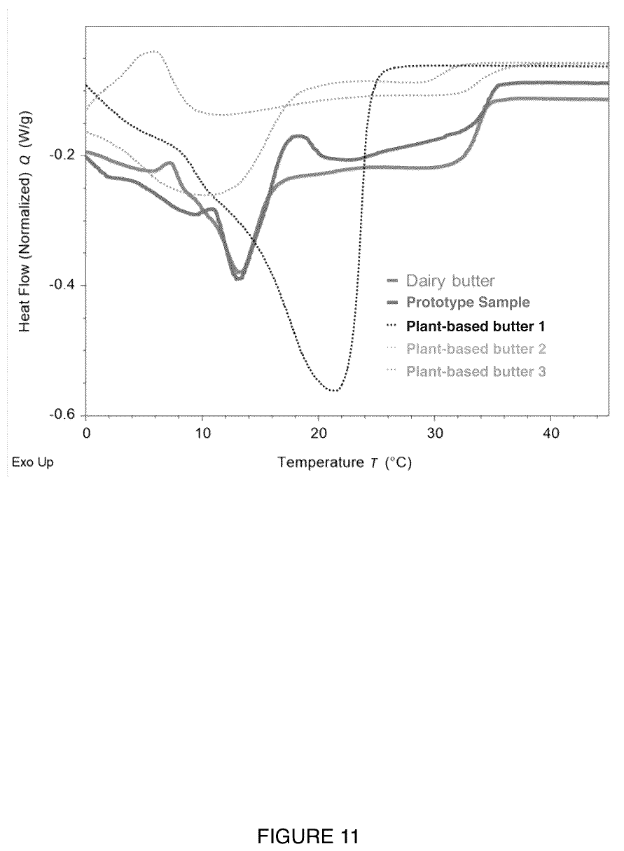

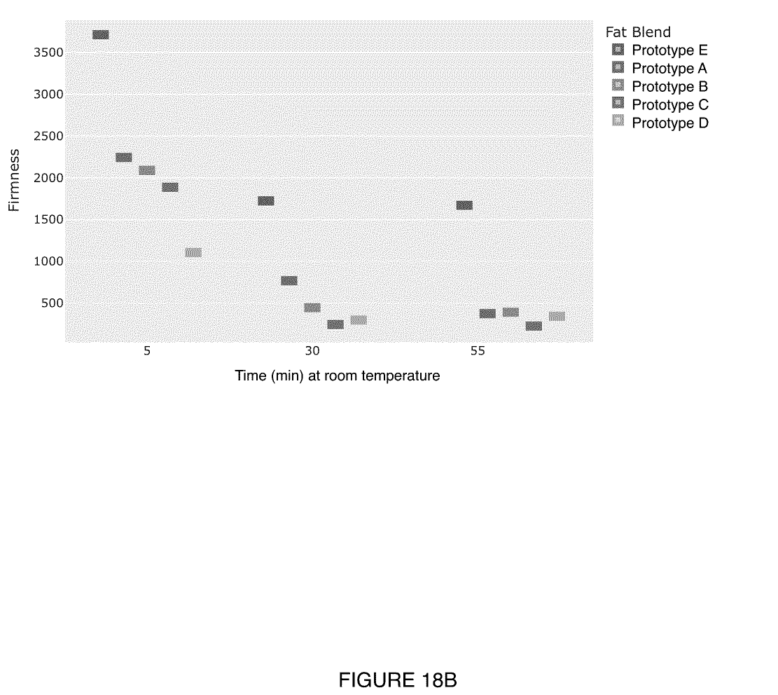

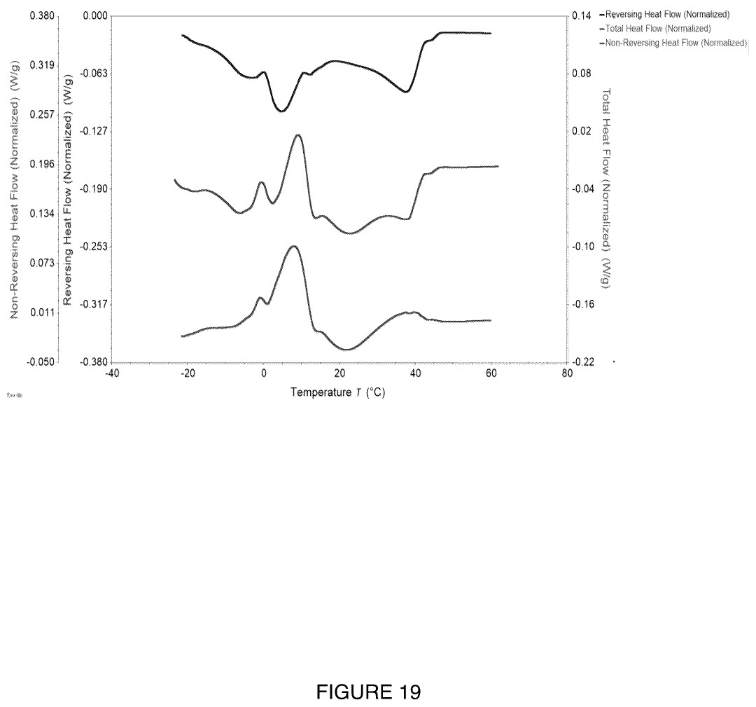

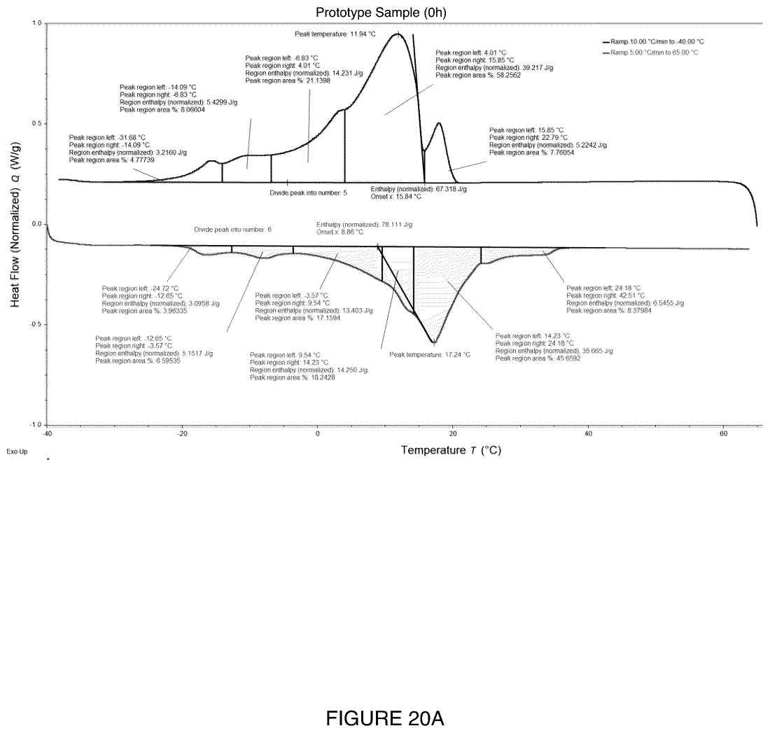

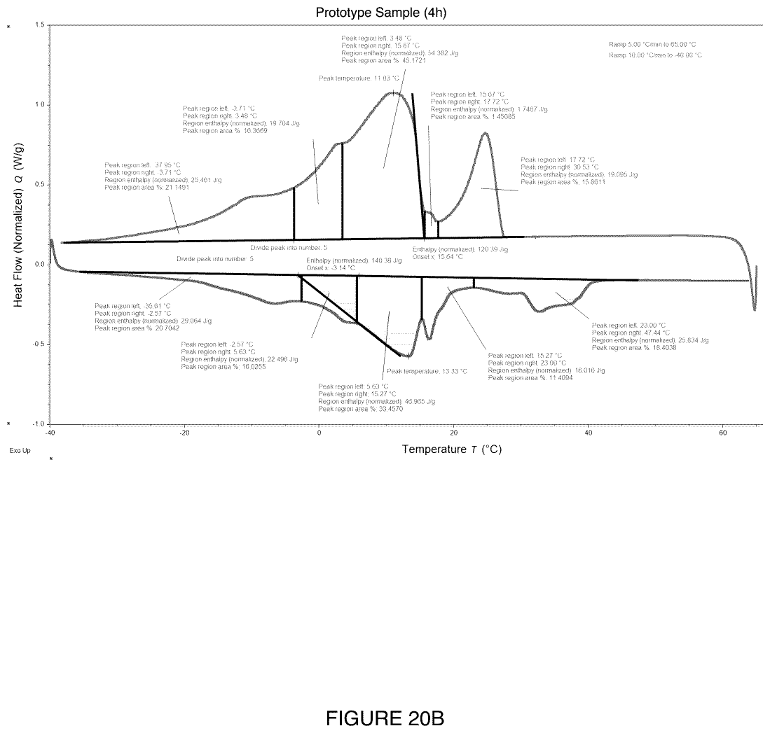

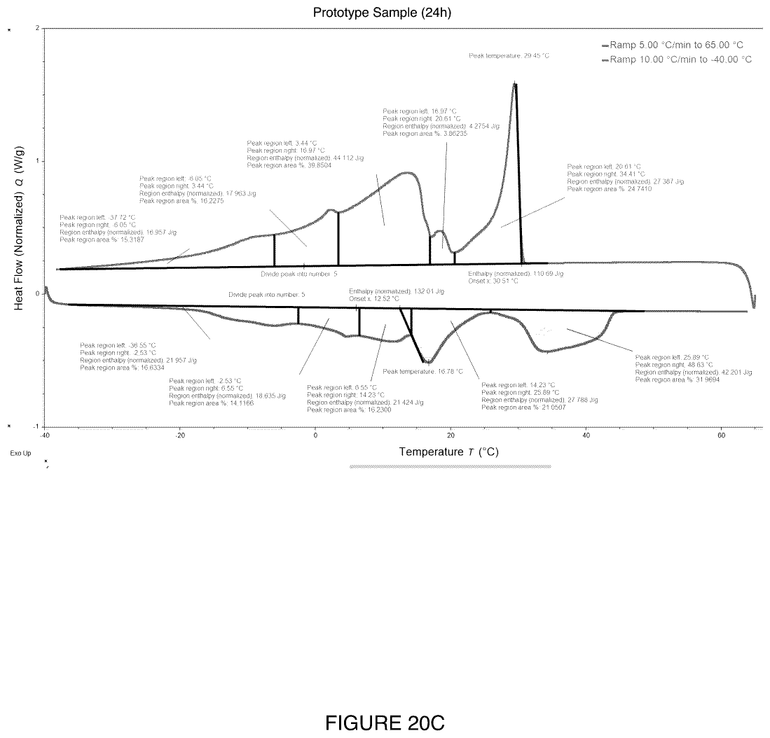

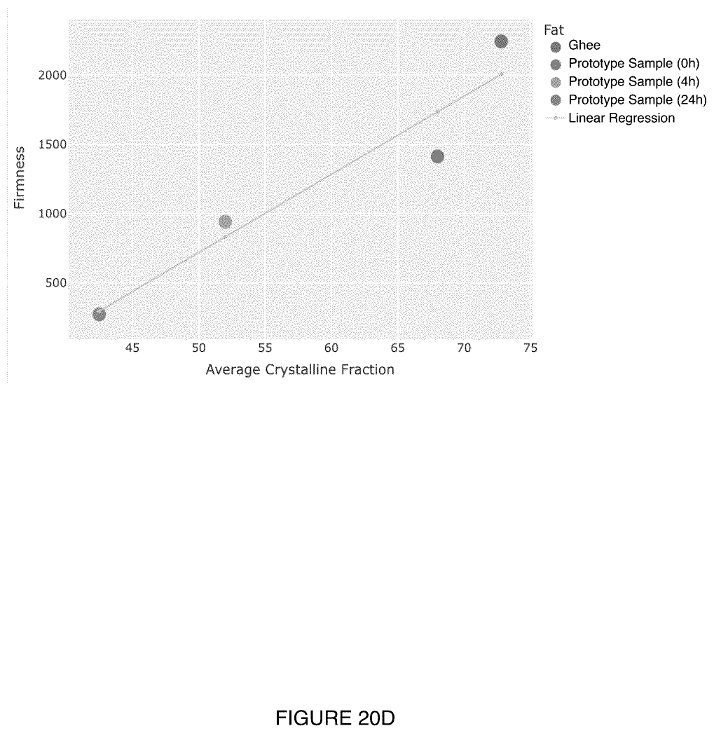

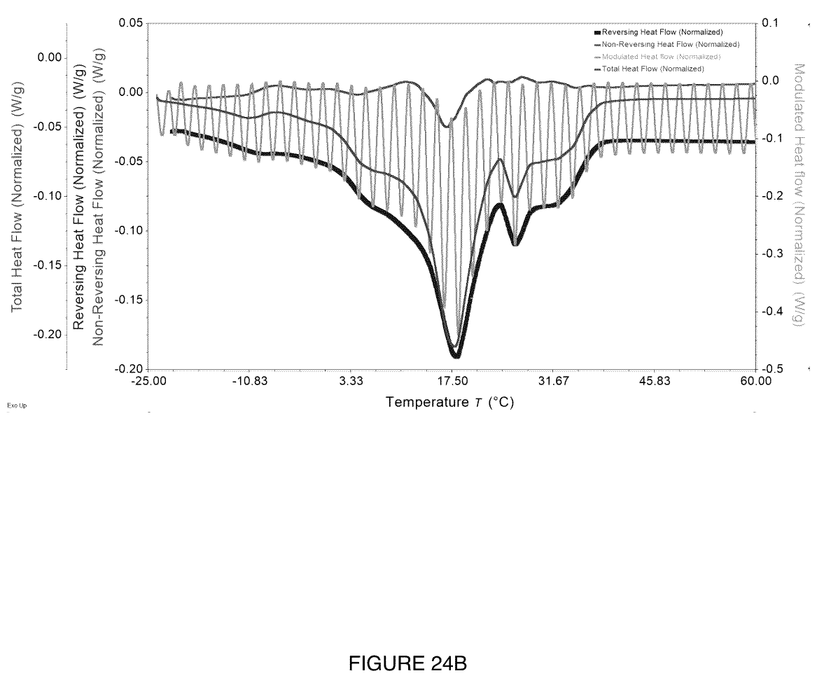

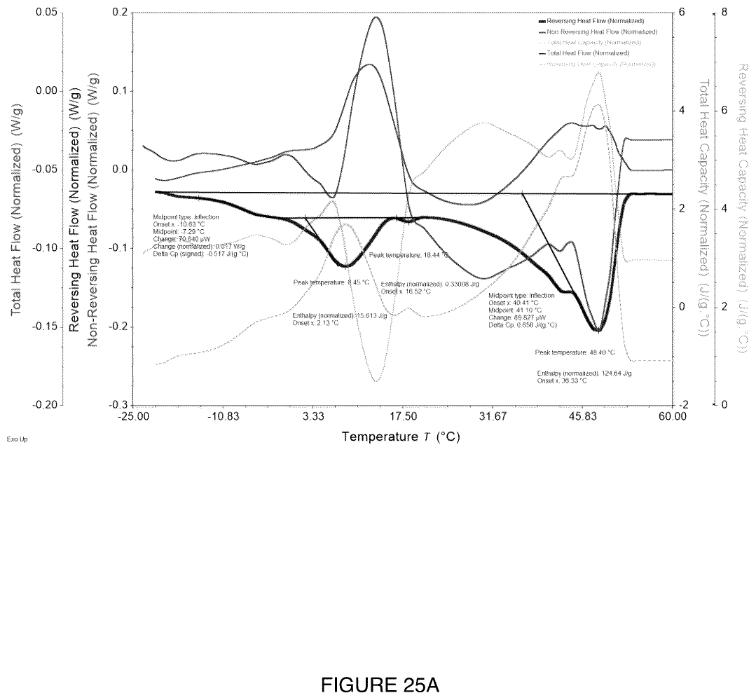

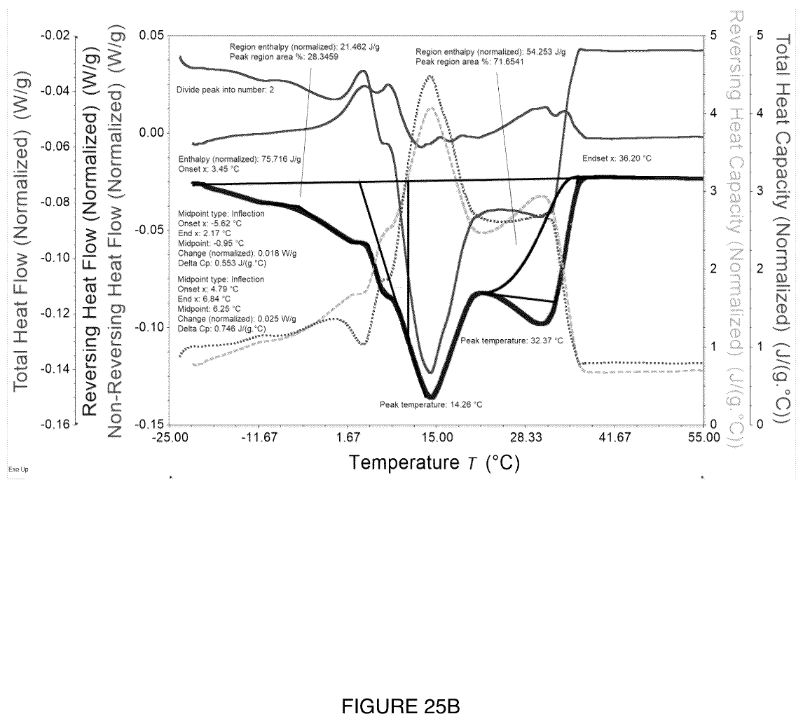

In a first variant, a characteristic value can include and/or be based on a heat flow signal (e.g., heat flow versus temperature). Examples are shown in FIG. 10, FIG. 11, FIG. 18A, FIG. 19, FIG. 20A, FIG. 20B, FIG. 20C, FIG. 25A, and FIG. 25B. The heat flow signal can optionally be determined using temperature modulated differential scanning calorimetry. For example, the temperature modulation can be a combination of linear temperature modulation and sinusoidal temperature modulation (e.g., simultaneous linear temperature modulation and sinusoidal temperature modulation); examples are shown in FIG. 24A and FIG. 24B. In specific examples, temperature modulated differential scanning calorimetry can enable: deconvolution of thermodynamic processes (e.g., changes in heat capacity, glass transitions, real and/or apparent melting, other structural changes, etc.) and kinetic processes (e.g., evaporation, crystallization, denaturation, decomposition, enthalpic recovery, other chemical changes, etc.), separation of time dependent and thermal dependent reactions, increased sensitivity to weak thermal events, reduced influence of instrumental drift, deconvolution of overlapping transitions, characterization of complex phase changes, and/or other advantages. The heat flow signal can be a total heat flow signal, a reversing heat flow signal (e.g., capturing thermodynamic processes), and/or a non-reversing heat flow signal (e.g., capturing kinetic processes); an example is shown in FIG. 19. For example, the heat flow signals can be of the form:

$$\frac{dQ}{dt} = {C}_{p} \frac{dT}{dt} + f ( T , t )$$

where Q is heat flux, T is temperature, t is time, Cₚ is heat capacity,

$$\frac{dQ}{dt}$$

is total heat flow, Cₚ

$$\frac{dT}{dt}$$

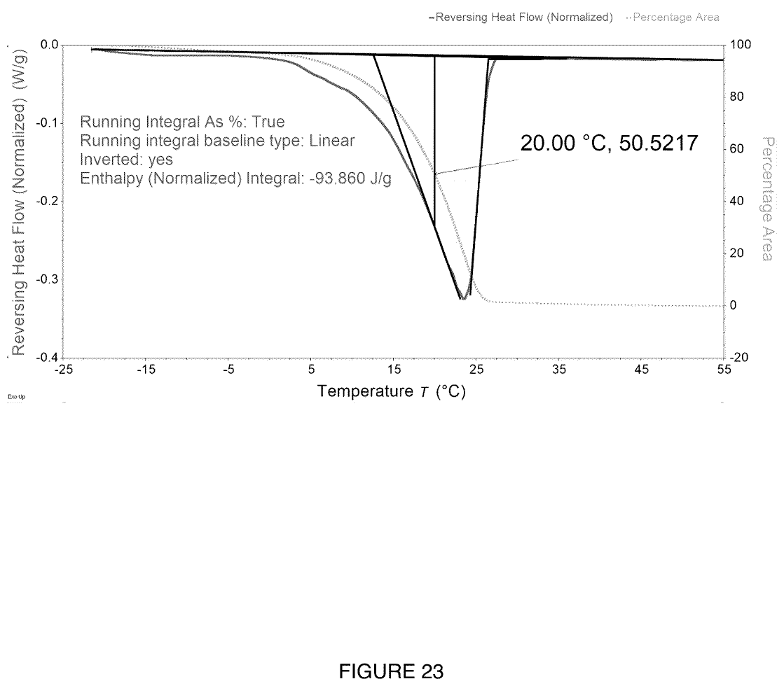

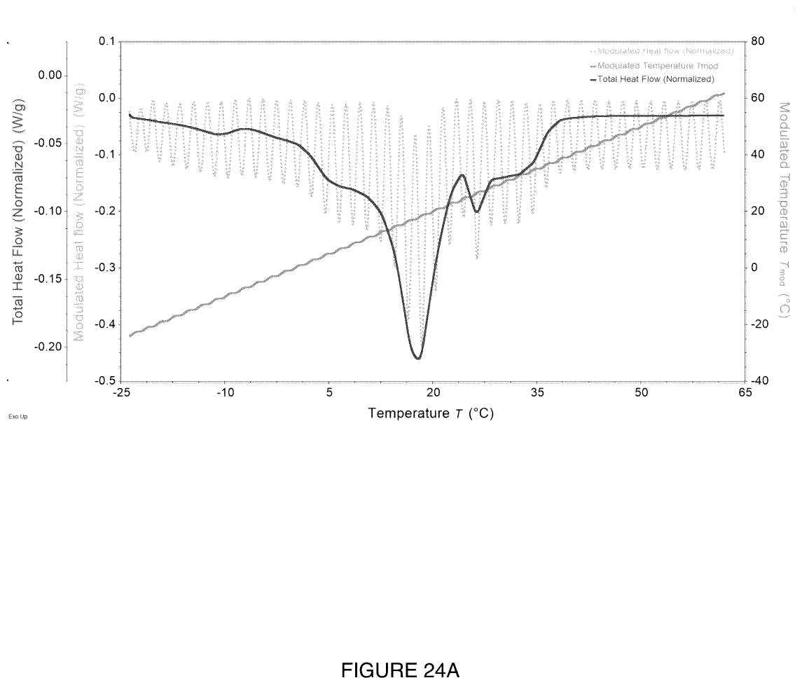

is reversing heat flow, and f(T, t) is non-reversing heat flow. The heat flow signal can optionally be a processed heat flow signal (e.g., a smoothed signal, a transformed signal, a signal segment, a normalized signal, a downsampled signal, an aggregate of signals, a derivative of a signal, an integrated signal, a weighted signal, solid fat content signal, melted fat content signal, etc.). In an example, the characteristic value can be an integral (e.g., a partial integral) of the heat flow signal and/or a feature value extracted from the integral (e.g., partial integral) of the heat flow signal. In a first example, the feature value can be solid fat content, determined by integrating all or a portion of the heat flow signal (e.g., reversing feat flow signal); an example is shown in FIG. 23. The solid fat content can include a solid fat content signal and/or a solid fat content value (e.g., a percentage and/or fraction of solid fat content relative to total fat content) at a temperature of interest. For example, a melted fat content value at a temperature of interest can be determined based on a first partial integration (e.g., area) of the reversing heat flow signal for the prototype sample before the temperature of interest; and a solid fat content value at the temperature of interest can be determined based on a second partial integration (e.g., area) of the reversing heat flow signal for the prototype sample after the temperature of interest. The melted fat content value can optionally be a fraction (e.g., the first partial integration relative to the total area; the first partial integration relative to the second integration; the inverse of the first partial integration; etc.) and/or a fraction converted to a percentage. The solid fat content value can optionally be a fraction (e.g., the second partial integration relative to the total area; the second partial integration relative to the first integration; the inverse of the second partial integration, etc.) and/or a fraction converted to a percentage. The temperature of interest can be between 0° C.-100° C. or any range or value therebetween (e.g., 20° C., 25° C., 30° C., 35° C., 40° C., 45° C., 50° C., 20° C.-35° C., 20° C.-40° C., 30° C.-40° C., etc.), but can alternatively be less than 0° C. or greater than 100° C. In a specific example, a solid fat content signal can include solid fat content values as a function of temperature (e.g., the inverse of the integral of the reversing heat flow signal, optionally converted to a percentage). In a second example, the feature value can be and/or be based on a derivative (e.g., average slope) of the solid fat content signal and/or any other processed heat flow signal (e.g., reversing heat flow signal). In a specific example, the feature value can be a derivative of the solid fat content signal and/or any other processed heat flow signal between a first temperature of interest (e.g., 15° C., 20° C., 25° C., 30° C., less than 15° C., greater than 30° C., and/or any other temperature of interest) and a second temperature of interest (e.g., 25° C., 30° C., 35° C., 37° C., 40° C., 45° C., 50° C., less than 25° C., greater than 50° C., and/or any other temperature of interest). In an illustrative example, the slope of the solid fat content signal in a temperature range of interest (e.g., 20° C. to 37° C.) can be used as a proxy for and/or used to determine mouthfeel, melt kinetics, and/or any other characteristic value. In specific examples, characteristic values can include and/or be determined based on one or more of: a processed or unprocessed heat flow signal (e.g., total heat flow signal, reversing heat flow signal, solid fat content signal, melted fat content signal, etc.), the derivative and/or integral of a processed or unprocessed heat flow signal, solid fat content at one or more temperatures of interest, the slope of an integrated heat flow signal, the slope of a solid fat content signal, melt/crystallization point, enthalpy, glass transition, melt transition, heat capacity, polymorphic form features, peaks of a heat flow signal, reversing heat capacity signal (e.g., derivative of the reversing heat flow signal, intercepts of reversing heat capacity and reversing heat flow signals, and/or any other characteristic value.

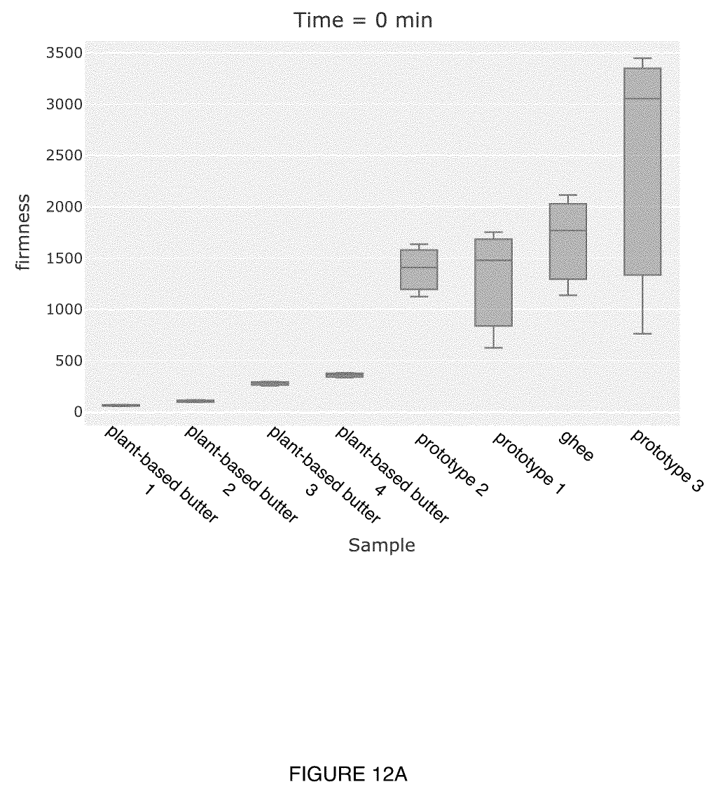

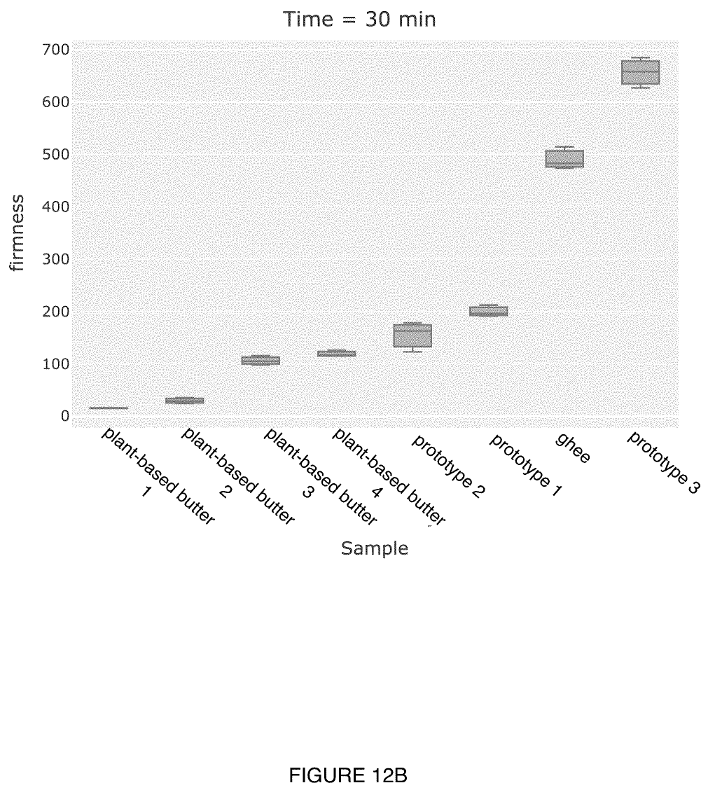

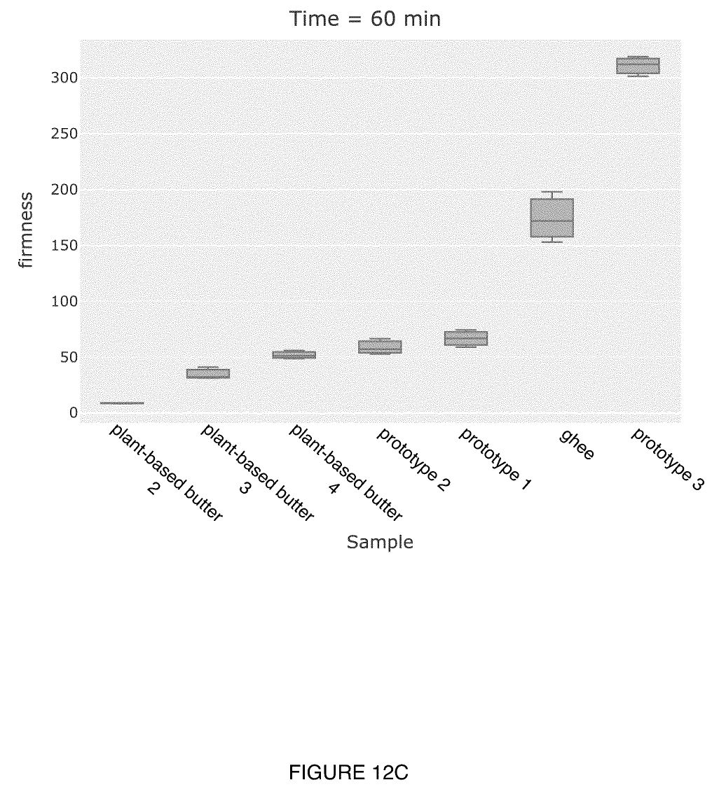

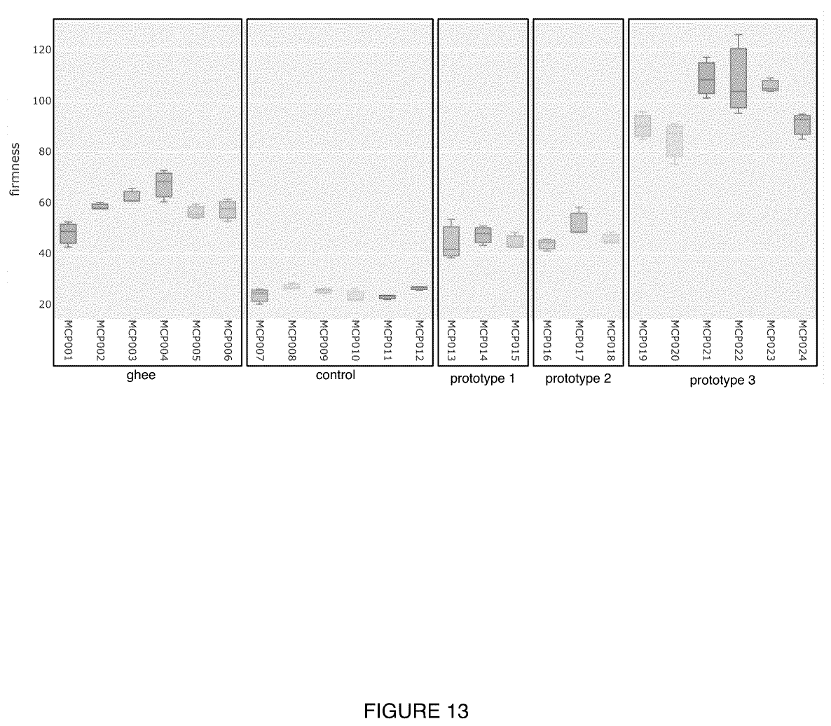

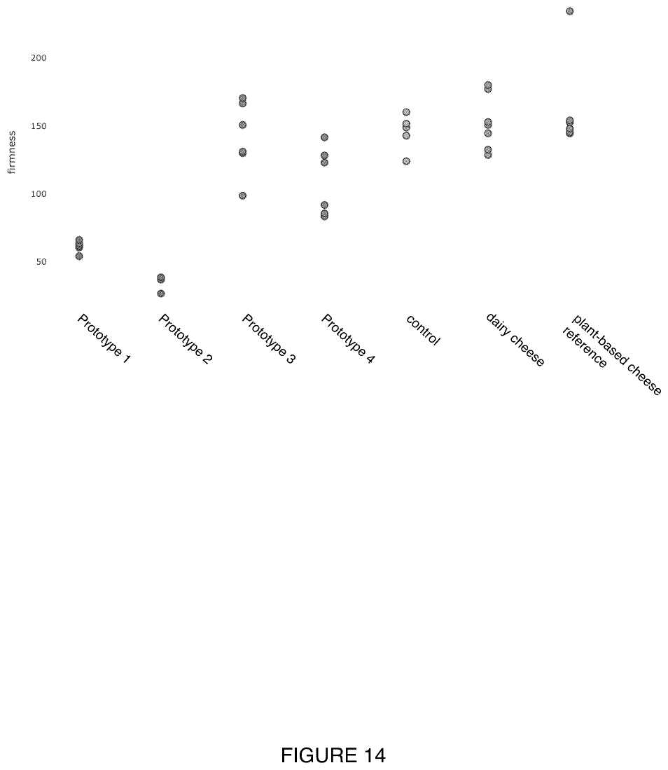

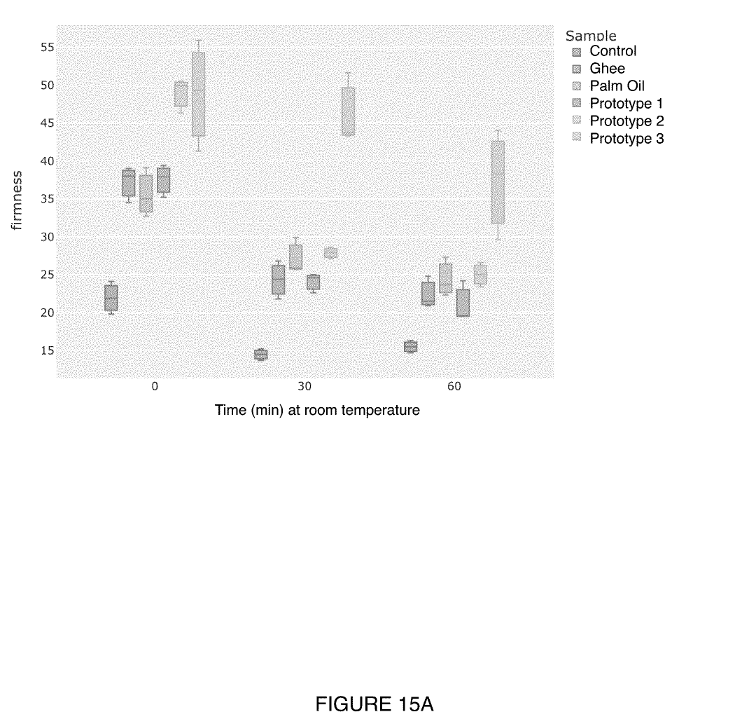

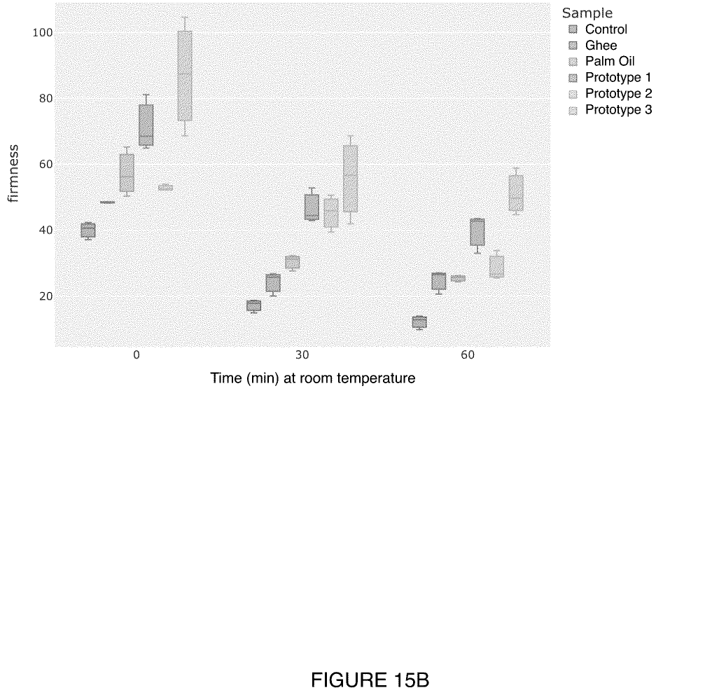

In a second variant, a characteristic value can include and/or be based on a texture signal. For example, the texture signal can be determined using a puncture assay with a texture analyzer. Examples are shown in FIG. 12A, FIG. 12B, FIG. 12C, FIG. 13, FIG. 14, FIG. 15A, FIG. 15B, and FIG. 18B. The texture signal can optionally be a processed texture signal (e.g., a smoothed signal, a transformed signal, a signal segment, a normalized signal, a downsampled signal, an aggregate of signals, a derivative of a signal, an integrated signal, a weighted signal, etc.). In an example, the characteristic value can include: a texture signal and/or a feature value extracted from the texture signal. The feature value can be a value for firmness and/or any other semantic or non-semantic feature of the texture signal.

In a third variant, a characteristic value can include and/or be based on saturated fatty acid composition. In a specific example, the characteristic value can include a proportion (e.g., percentage) of each saturated fatty acid in the prototype sample (e.g., lauric acid, myristic acid, palmitic acid, stearic acid, and/or any other saturated fatty acid). The saturated fatty acid composition can be determined based on the sample vector (e.g., based on the composition of lipids in the prototype sample). The saturated fatty acid composition can be determined using literature values (e.g., a known saturated fatty acid composition for each lipid in the prototype sample), a database, estimated and/or predicted values, and/or be otherwise determined.

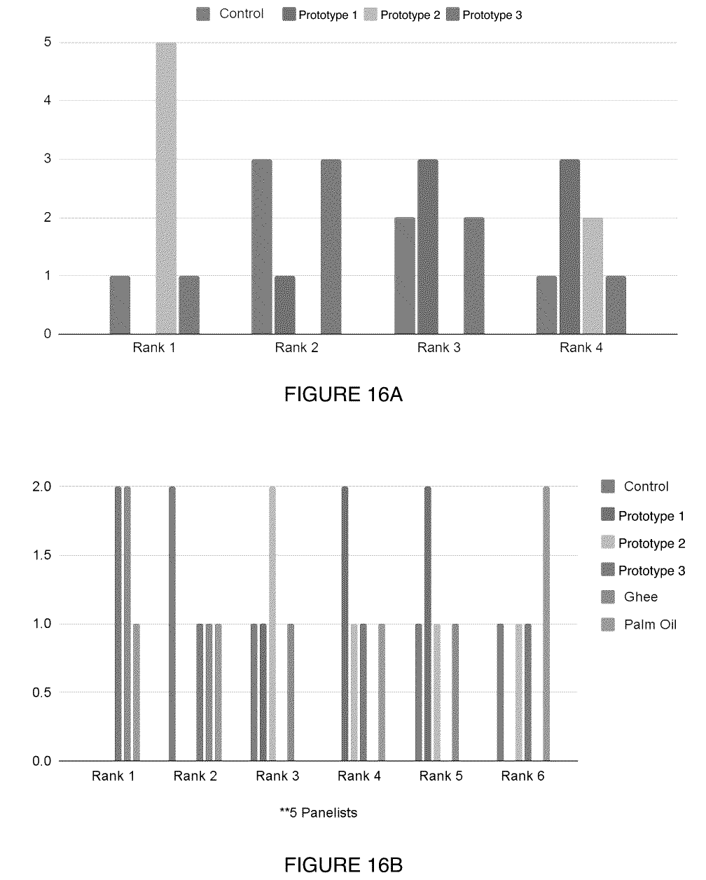

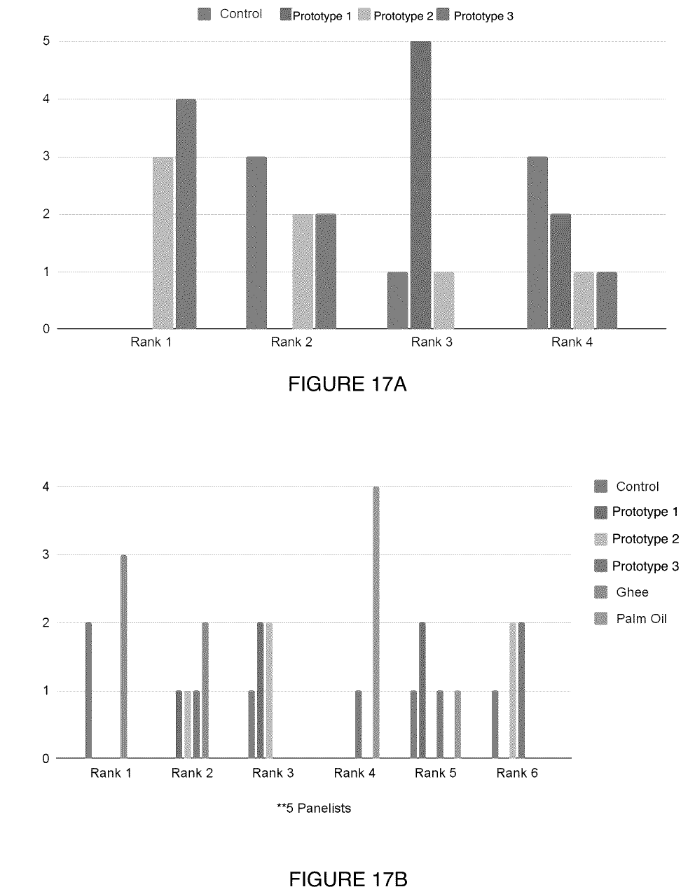

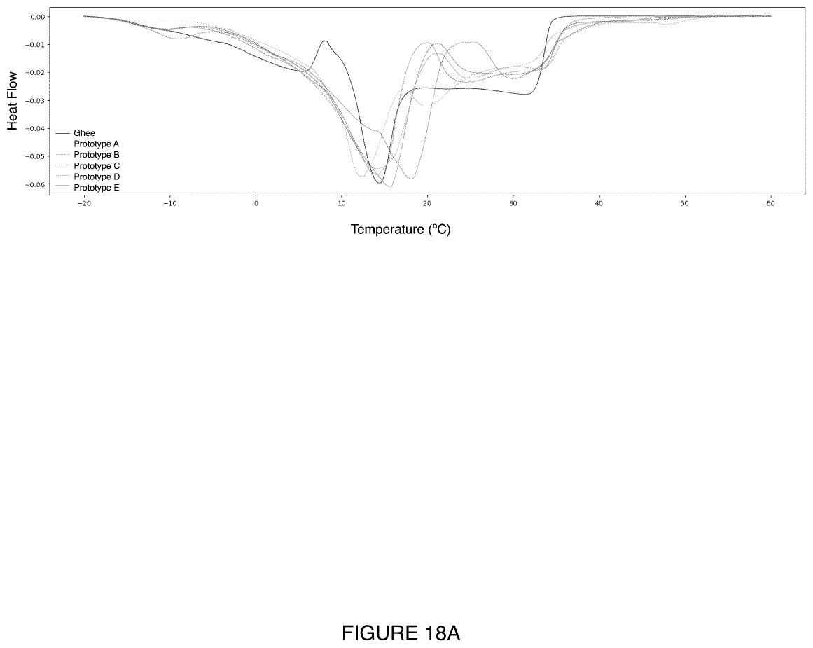

In a fourth variant, a characteristic value can include and/or be based on sensory panel data. For example, the characteristic value can include and/or be based on sample rankings from sensory panelists. Examples are shown in FIG. 16A, FIG. 16B, FIG. 17A, and FIG. 17B.

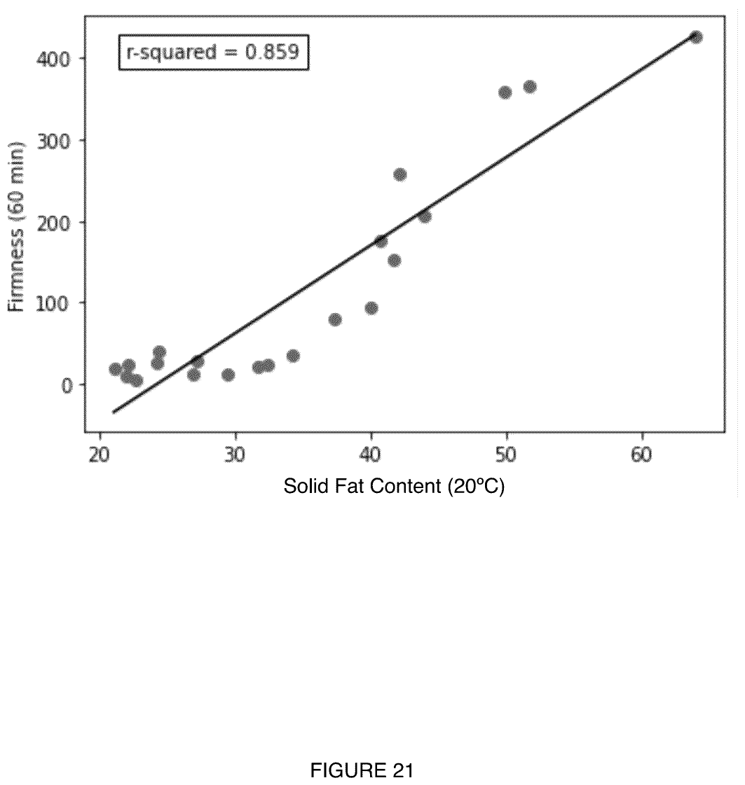

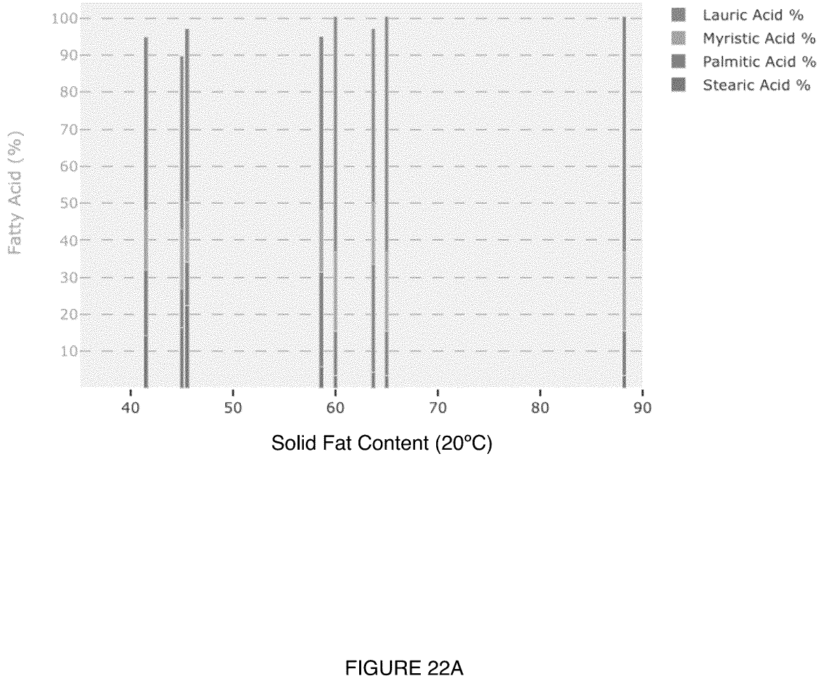

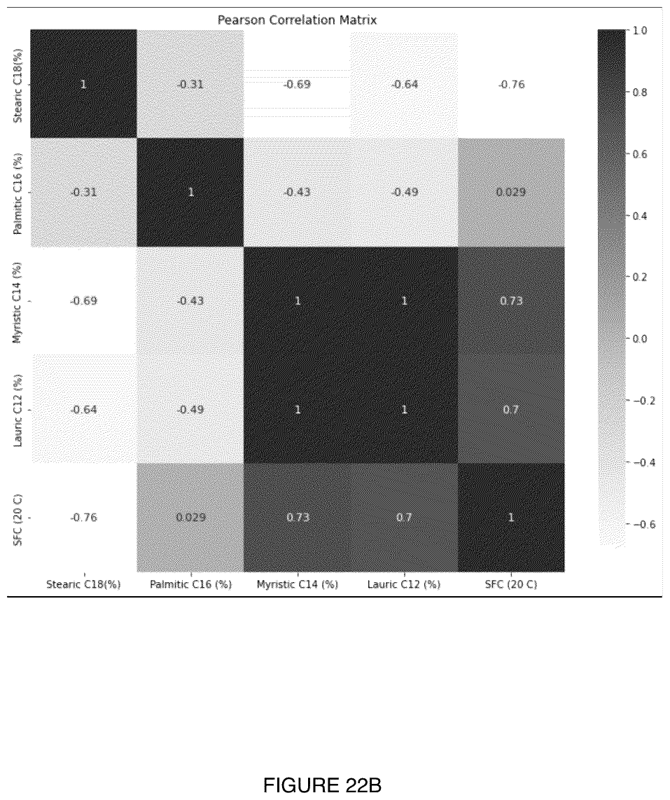

In a fifth variant, a characteristic value can be predicted based on one or more other characteristic values. For example, a first characteristic value (e.g., reversing heat flow signal, solid fat content, etc.) can be correlated to a second characteristic value (e.g., values for firmness, waxiness, graininess, etc.), wherein the first characteristic value can be used to predict the second characteristic value. Examples are shown in FIG. 20D, FIG. 21, FIG. 22A, and FIG. 22B. In a specific example, the first characteristic value can be associated with (e.g., determine using) a prototype sample at a first processing stage (e.g., an intermediate product), and the second characteristic value can be associated with the prototype sample at a second processing stage (e.g., an end-stage product). In an illustrative example, a heat flow signal determined for an intermediate product can be used to predict a characteristic value for an end-stage product.

The characteristic values for the prototype sample can optionally be determined using multiple iterations of the previous variants (e.g., multiple characteristic values determined based on the heat flow signal), using a combination of the previous variants (e.g., a first characteristic value determined based on the heat flow signal and a second characteristic value determined based on the texture signal), and/or otherwise determined.

Characteristic values can optionally be determined for the prototype sample at a target temperature. In a first example, when experimentally analyzing the prototype sample to determine a characteristic value (e.g., when measuring a functional property signal such as a heat flow signal, texture signal, etc.), the temperature of the prototype sample can be at a target temperature. The target temperature can be between 0° C.-100° C. or any range or value therebetween (e.g., 5° C.-20° C., 20° C.-25° C., 15° C.-30° C., 30° C.-50° C., room temperature, etc.), but can alternatively be less than 0° C. or greater than 100° C. In a second example, when experimentally analyzing the prototype sample to determine a characteristic value, the prototype sample can be exposed to a target temperature for a target time period. The target temperature can be between 0° C.-100° C. or any range or value therebetween (e.g., 5° C.-20° C., 20° C.-25° C., 15° C.-30° C., 30° C.-50° C., room temperature, etc.), but can alternatively be less than 0° C. or greater than 100° C. The target time period can be between 0 min-10 weeks or any range or value therebetween (e.g., 10 min, 20 min, 60 min, at least 5 min, at least 10 min, at least 20 min, at least 60 min, 3 weeks, 6 weeks, etc.), but can alternatively be less than 0 min or greater than 10 weeks. In a specific example, the prototype sample can be maintained at a first target temperature (e.g., below room temperature), and then exposed to a second target temperature (e.g., room temperature) for the target time period before measuring the experimental data used to determine the characteristic value.

However, prototype characteristic values can be otherwise determined.

Determining target characteristic values S150 functions to quantify characteristics of a target. Target characteristic values preferably include characteristic values for a physical target sample, but can alternatively include characteristic values for a hypothetical target and/or other characteristic values. S150 can be performed before S100, after S100, after manufacturing the target sample, and/or at any other suitable time.

The target characteristic values that are determined are preferably values for the same characteristics as those determined for the prototype sample (e.g., S100), but can alternatively be different. Target characteristic values can optionally be positive target characteristic values (e.g., where all or parts of the method can identify a prototype sample that has characteristic values similar to the target characteristic values) and/or a negative target (e.g., where all or parts of the method can identify a prototype sample that has characteristic values dissimilar to the target characteristic values).

The target characteristic values can be experimentally determined (e.g., using S100 methods for a target sample), predetermined, computationally determined (e.g., based on a desired change in characteristic values for a previously analyzed sample, based on predicted characteristic values, etc.), manually determined, randomly determined, and/or otherwise determined.

However, target characteristic values can be otherwise determined.

Determining a similarity score S200 functions to compare the prototype characteristic values to the target characteristic values and/or to generate a training target for S300. S200 can be performed after S100, after S150, and/or at any other suitable time.

The similarity score can be quantitative (e.g., a single value, a set of values, a curve, etc.), qualitative, relative, discrete, continuous, a classification, numeric, binary, and/or other score. The similarity score can include or be based on: differences (e.g., weighted differences), distances, ratios, regressions, residuals, clustering metrics, statistical measures, sample cost, and/or any other evaluation metrics.

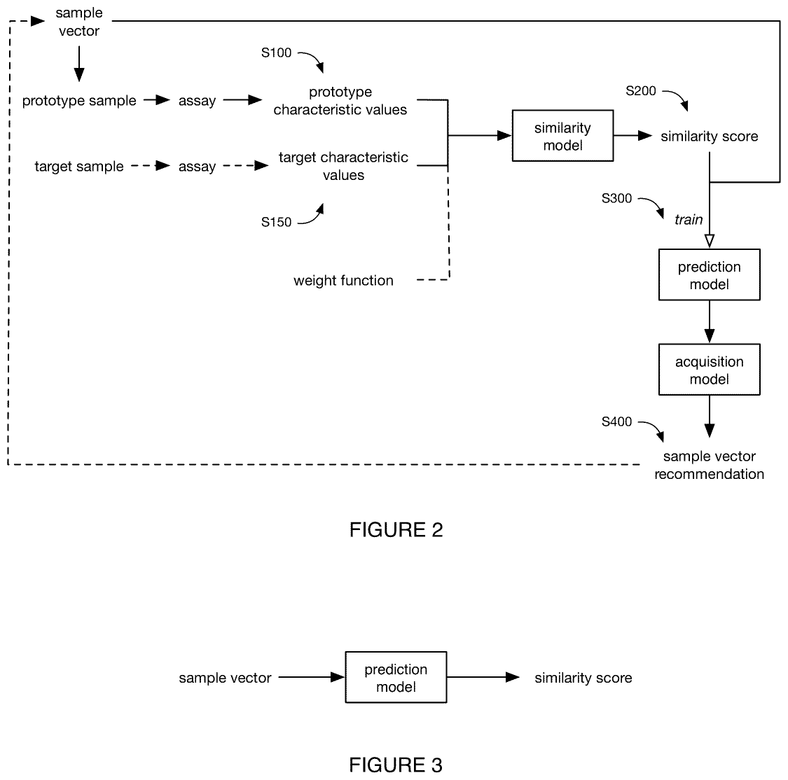

The similarity score is preferably determined using a similarity model (e.g., example shown in FIG. 2), but can be otherwise determined. Inputs to the similarity model can include prototype characteristic values, target characteristic values, combined characteristic values, and/or any other inputs. Outputs from the similarity model can include a similarity score and/or any other outputs. The similarity model can include classical or traditional approaches, machine learning approaches, and/or be otherwise configured. The similarity model can use one or more of: regression (e.g., linear regression, non-linear regression, logistic regression, etc.), decision tree, LSA, clustering (e.g., k-means clustering, hierarchical clustering, etc.), association rules, dimensionality reduction (e.g., PCA, t-SNE, LDA, etc.), neural networks (e.g., CNN, DNN, CAN, LSTM, RNN, FNN, encoders, decoders, deep learning models, transformers, etc.), ensemble methods, optimization methods (e.g., Bayesian optimization, multi-objective Bayesian optimization, Bayesian optimal experimental design, etc.), classification, rules, heuristics, equations (e.g., weighted equations, etc.), selection (e.g., from a library), lookups, regularization methods (e.g., ridge regression), Bayesian methods (e.g., Naiive Bayes, Markov), instance-based methods (e.g., nearest neighbor), kernel methods, support vectors (e.g., SVM, SVC, etc.), statistical methods (e.g., probability), comparison methods (e.g., matching, distance metrics, thresholds, etc.), deterministics, genetic programs, weight functions, and/or any other suitable model. The models can include (e.g., be constructed using) a set of input layers, output layers, and hidden layers (e.g., connected in series, such as in a feed forward network; connected with a feedback loop between the output and the input, such as in a recurrent neural network; etc.; wherein the layer weights and/or connections can be learned through training); a set of connected convolution layers (e.g., in a CNN); a set of self-attention layers; and/or have any other suitable architecture. The similarity model can be trained, learned, fit, predetermined, and/or can be otherwise determined.

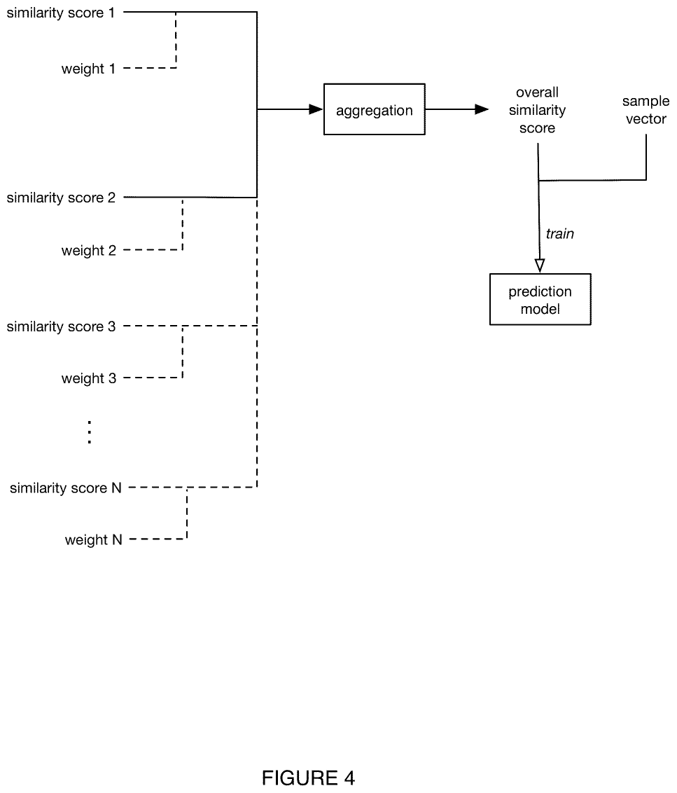

The similarity score can optionally be an aggregate similarity score (e.g., overall similarity score). An example is shown in FIG. 4. For example, one similarity score can be determined for each characteristic in a set of characteristics, wherein the similarity scores for different characteristics are aggregated (e.g., using weighted aggregation, wherein each similarity score is associated with a weight) to generate an aggregate similarity score. An aggregate similarity score can be based on a set of similarity scores, wherein a number of similarity score in the set of similarity scores can be: 1, 2, 3, 4, 5, greater than 5, and/or any other number of similarity scores. In a specific example, an aggregate similarity score can be based on a first similarity score (e.g., determined based on a first set of prototype characteristic values and a first set of target characteristic values), a second similarity score (e.g., determined based on a second set of prototype characteristic values and a second set of target characteristic values), optionally a third similarity score (e.g., determined based on a third set of prototype characteristic values and a third set of target characteristic values), and/or any other similarity scores. Aggregating similarity scores can include summation (e.g., weighted summation), averaging (e.g., weighting averaging), any other statistical methods, vectorizing (e.g., combing multiple similarity into a vector of similarity scores), and/or any other aggregation method. Additionally or alternatively, the similarity score can be a multi-dimensional similarity score (e.g., wherein each dimension represents a different characteristic), wherein the optimization is performed over a multi-dimensional space. Additionally or alternatively, a different method instance can be performed for each characteristic. The similarity score can optionally be determined based on sample cost (e.g., weighted to decrease the similarity score when the prototype sample's monetary cost decreases).

In variants, the similarity score can be determined based on a comparison between prototype characteristic values and target characteristic values. In a specific example, prototype characteristic values can include a prototype functional property feature value (e.g., extracted from a prototype functional property signal), and target characteristic values can include a target functional property feature value (e.g., extracted from a target functional property signal), wherein the similarity score can be based on a comparison between the prototype functional property feature value and target functional property feature value.

Determining the similarity score based on a comparison between comparing prototype characteristic values and target characteristic values can optionally include determining combined characteristic values, optionally processing the combined characteristic values, and determining the similarity score based on the (processed or unprocessed) combined characteristic values. In a first example, combined characteristic values can include a difference between a prototype characteristic value (e.g., a firmness value for the prototype sample, a solid fat content value for the prototype sample, etc.) and a target characteristic value (e.g., a firmness value for the target sample, a solid fat content value for the target sample, etc.). In a second example, combined characteristic values (e.g., a combined functional property signal) can include a difference between prototype characteristic values (e.g., a heat flow signal for the prototype sample) and target characteristic values (e.g., a heat flow signal for the target sample). The combined characteristic values can optionally be processed, wherein the similarity score can be determined based on the processed combined characteristic values. In examples, processing the combined characteristic values can include: smoothing, transforming (e.g., squaring, transforming between domains, etc.), segmenting, normalizing, downsampling, aggregating, integrating, differentiating, weighting, a combination thereof, and/or any other processing methods. In examples, the similarity score can be and/or be based on: a maximum value of the combined characteristic values, integrated combined characteristic values (e.g., an area under all or a portion of the a curve for the combined characteristic values), a sum of all or a portion of the combined characteristic values, the combined characteristic values (e.g., a curve defining a set of processed or unprocessed differences), and/or any other metric evaluating the prototype characteristic values.

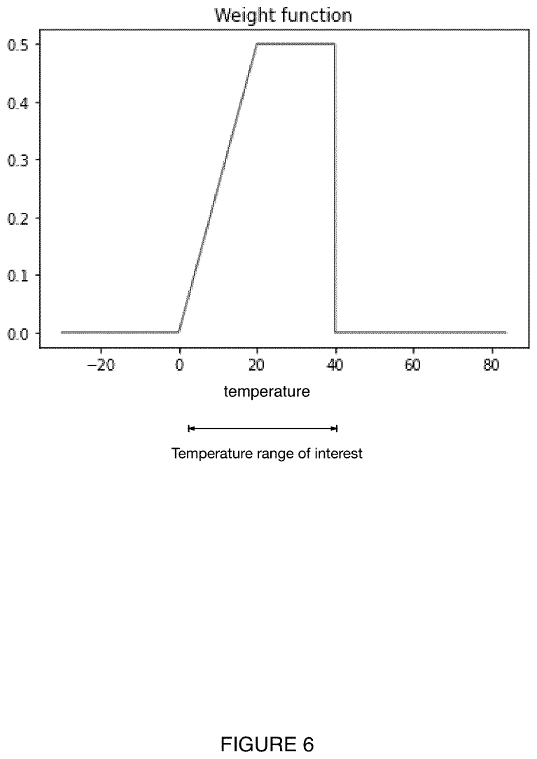

The similarity score can optionally be determined based on a weight function. The weight function can be used to determine weighted characteristic values (e.g., a weighted functional property signal), the similarity score, and/or another datum. The weight function is preferably a function specifying weight versus a characteristic assay independent variable (e.g., wherein the independent variable for a DSC assay is temperature), but can additionally or alternatively be a function specifying weight versus a characteristic (e.g., wherein different characteristics are weighted higher than others), and/or can be any other weight function. For example, the weight function can be a temperature weight function specifying weight versus temperature. In a specific example, the weight function can specify nonzero (e.g., positive) weights for characteristic values within a temperature range of interest—between a first target temperature and a second target temperature—and specify zero weight for characteristic values outside the temperature range of interest; an example is shown in FIG. 6. The first target temperature defining the temperature range of interest can be between 0° C.-40° C. or any range or value therebetween (e.g., 0° C., 10° C., 15° C., 20° C., 25° C., 30° C., 0° C.-20° C., 10° C.-30° C., at least 0° C., at least 10° C., etc.), but can alternatively be less than 0° C. or greater than 40° C. The second target temperature defining the temperature range of interest can be between 20° C.-60° C. or any range or value therebetween (e.g., 20° C., 30° C., 35° C., 40° C., 45° C., 50° C., 20° C.-40° C., 30° C.-50° C., less than 60° C., less than 50° C., less than 40° C., etc.), but can alternatively be less than 20° C. or greater than 60° C. The weight function can be or include: a step function, a linear function, a non-linear function, and/or any other function.

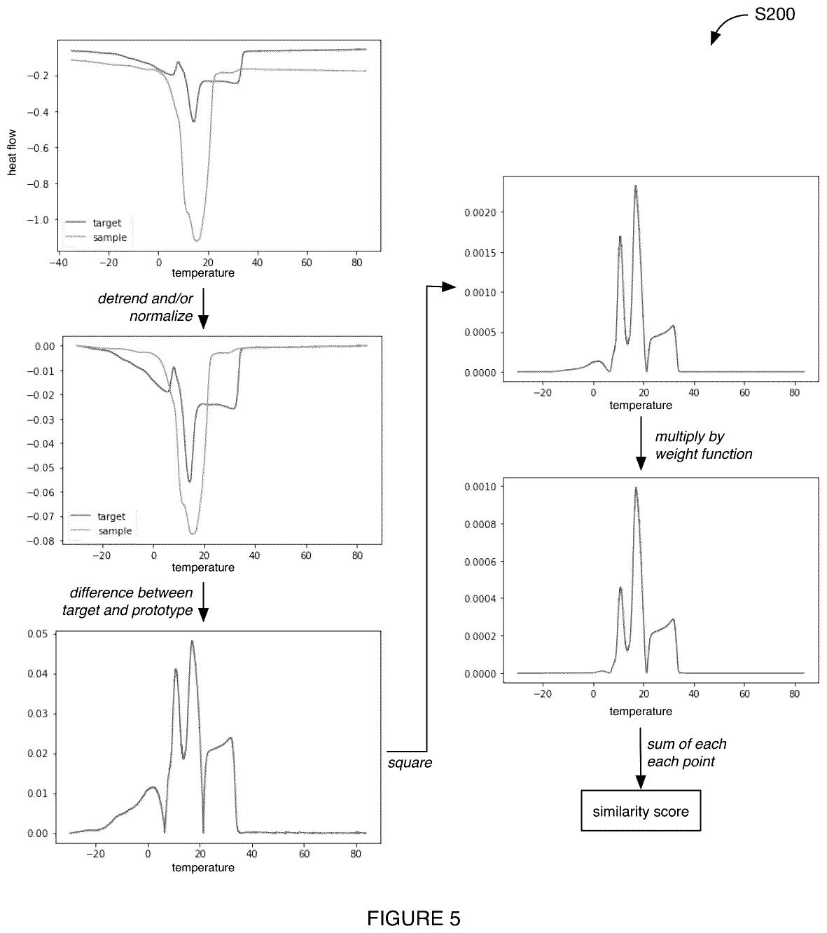

The weight function is preferably used to weight characteristic values (e.g., prototype characteristic values, target characteristic values, combined characteristic values, processed characteristic values, etc.). In a first example, prototype characteristic values and target characteristic values can each be weighted according to the weight function, wherein the weighted prototype characteristic values and the weighted target characteristic values can be used to determine the similarity score (e.g., determining the similarity score based on a comparison between the weighted prototype characteristic values and the weighted target characteristic values). In a second example, determining the similarity score can include: determining combined characteristic values (e.g., a combined functional property signal) by comparing (e.g., taking the difference between) prototype characteristic values (e.g., a prototype functional property signal) and target characteristic values (e.g., a target functional property signal), weighting the combined characteristic values (e.g., using a weight function), and determining the similarity score based on the weighted combined characteristic values (e.g., processed functional property signal, weighted functional property signal, etc.). In a specific example, determining the similarity score can include: taking the difference between the target characteristic values and the prototype characteristic values (e.g., a difference between prototype heat flow values and target heat flow values at each of a set of temperatures), optionally processing the difference (e.g., squaring the difference), weighting the difference (e.g., using a weight function), and determining the similarity score based on the weighted difference. An example is shown in FIG. 5.

However, the similarity score can be otherwise determined.

Training a prediction model S300 functions to train a model to predict a similarity score for a prototype sample and/or otherwise evaluate the prototype sample. S300 can be performed after S200 (e.g., iteratively after each S200 instance) and/or at any other suitable time.

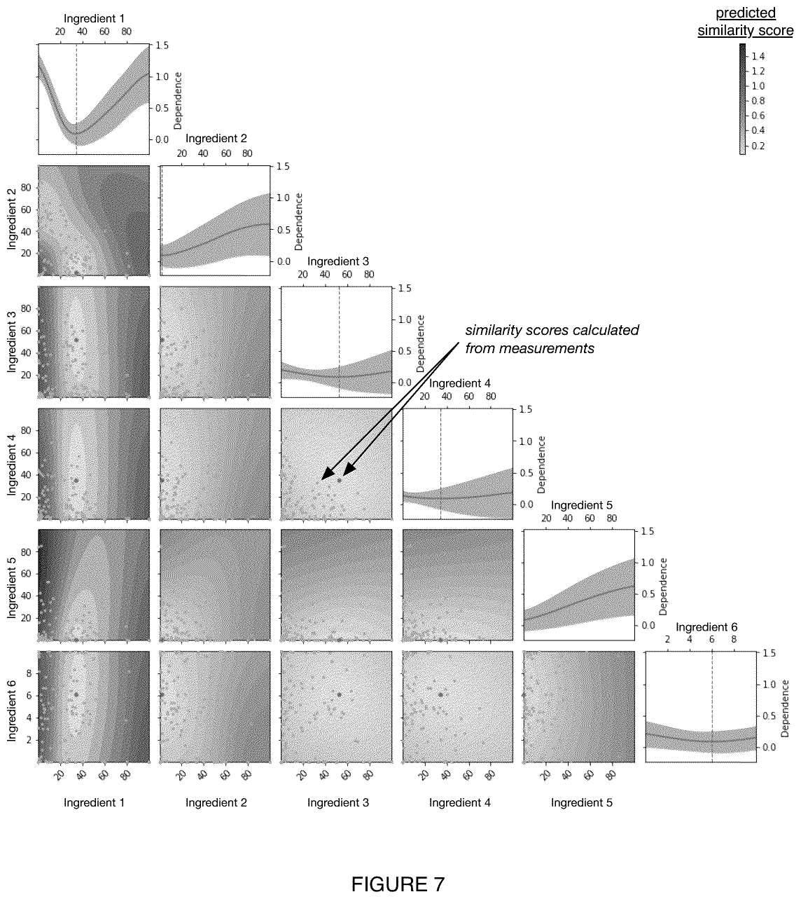

Inputs to the prediction model can include one or more sample vectors (e.g., a vectorized composition for a prototype sample), prototype sample cost, and/or any other prototype and/or target information. For example, inputs to the prediction model can include manufacturing variable values (e.g., composition and/or other process parameters) for a prototype sample. Outputs from the prediction model preferably include a similarity score (e.g., a predicted similarity score), but can alternatively include characteristic values (e.g., predicted characteristic values) and/or other prototype sample information. An example prediction model is shown in FIG. 3. In a first specific example, the prediction model (e.g., a surrogate model approximating an objective function) ingests a single sample vector and outputs a corresponding predicted similarity score. In a second specific example, the prediction model (e.g., a surrogate model approximating an objective function) ingests a set of sample vectors and outputs an n-dimensional similarity score, with 1 dimension for each sample vector component, such that the prediction model outputs a predicted similarity score for all sample vectors in the set. An example is shown in FIG. 7.

The prediction model can include classical or traditional approaches, machine learning approaches, and/or be otherwise configured. The prediction model can use one or more of: regression (e.g., linear regression, non-linear regression, logistic regression, etc.), decision tree, LSA, clustering (e.g., k-means clustering, hierarchical clustering, etc.), association rules, dimensionality reduction (e.g., PCA, t-SNE, LDA, etc.), neural networks (e.g., CNN, DNN, CAN, LSTM, RNN, FNN, encoders, decoders, deep learning models, transformers, etc.), ensemble methods, optimization methods (e.g., models used in: Bayesian optimization, multi-objective Bayesian optimization, Bayesian optimal experimental design, any other Bayesian optimization method, etc.), Bayesian surrogate models, classification, rules, heuristics, equations (e.g., weighted equations, etc.), selection (e.g., from a library), lookups, regularization methods (e.g., ridge regression), Bayesian methods (e.g., Naiive Bayes, Markov), instance-based methods (e.g., nearest neighbor), kernel methods (e.g., Gaussian processes), support vectors (e.g., SVM, SVC, etc.), statistical methods (e.g., probability), comparison methods (e.g., matching, distance metrics, thresholds, etc.), deterministics, genetic programs, approximation models, probability methods, and/or any other suitable model. The models can include (e.g., be constructed using) a set of input layers, output layers, and hidden layers (e.g., connected in series, such as in a feed forward network; connected with a feedback loop between the output and the input, such as in a recurrent neural network; etc.; wherein the layer weights and/or connections can be learned through training); a set of connected convolution layers (e.g., in a CNN); a set of self-attention layers; and/or have any other suitable architecture.

The prediction model can be trained using Bayesian optimization methods, fitting, interpolation and/or approximation (e.g., using gaussian processes), self-supervised learning, semi-supervised learning (e.g., positive-unlabeled learning, etc.), supervised learning, unsupervised learning, transfer learning, reinforcement learning, backpropagation, and/or any other methods. For example, the prediction model can be trained to predict a similarity score given a sample vector. The prediction model can be learned or trained on: labeled data (e.g., data labeled with the target label), unlabeled data, positive training sets (e.g., a set of data with true positive labels), negative training sets (e.g., a set of data with true negative labels), and/or any other suitable set of data. Training data (e.g., training targets) used to train the prediction model can include a sample vector and one or more associated similarity scores (e.g., the sample vector is labeled with one or more similarity scores) for each of a set of training prototype samples. For example, the prediction model can be trained based on a comparison between prototype characteristic value(s) (e.g., prototype functional property signal, prototype functional property feature value(s), etc.) and target characteristic value(s) (e.g., target functional property signal, target functional property feature value(s)).

In a first variant, the prediction model is a surrogate model (e.g., an approximation for an objective function), wherein the prediction model is trained via Bayesian optimization methods (e.g., interpolation using gaussian processes). For example, S300 can include updating a prior prediction model such that the updated prediction model output (e.g., including a posterior distribution over the objective function) approximates the similarity score (function evaluation) given the respective sample vector input. In a second variant, the prediction model can be a neural network trained to predict a similarity score given a sample vector.

In a first example, the prediction model includes a single model (e.g., surrogate model) trained using a set of sample vectors, each sample vector labeled with a single similarity score (e.g., an aggregate similarity score). In a second example, the prediction model includes a single model trained using a set of sample vectors, each sample vector labeled with multiple similarity scores (e.g., a vector of similarity scores). In a third example, the prediction model includes multiple models (e.g., multiple surrogate models), each trained using a set of sample vectors, each sample vector labeled with one or more similarity scores. In a specific example, each constituent model of the prediction model can correspond to a characteristic.

The prediction model can be specific and/or generalized to: sets of ingredients, sets of process parameters, characteristics, the target sample, and/or any other information.

However, the prediction model can be otherwise trained.

Determining a sample recommendation S400 functions to recommend prototype samples for additional training data (e.g., wherein knowing the characteristic values for the recommended prototype samples would improve the prediction model), to recommend a prototype sample that will likely have characteristic values similar to target characteristic values (e.g., a low similarity score), and/or any other sample recommendations. S400 can be performed after S300 and/or at any other suitable time. In an example, S100, S200, S300, and/or S400 can be iteratively performed until characteristic values for a sample recommendation are within a threshold of the target characteristic values, a similarity score is below a threshold, and/or any other stop condition. In another example, the sample recommendation can be directly predicted by the prediction model (e.g., wherein the prediction model predicts a sample formulation that minimizes or maximizes the similarity score).

The sample recommendation can be a sample vector (e.g., a sample vector recommendation), wherein the sample vector recommendation can define a next prototype sample to manufacture for characteristic value determination (e.g., for a subsequent iteration of S100). For example, the sample recommendation can be a set of manufacturing variable values (e.g., a composition) for a new prototype sample.

The sample recommendation is preferably determined using an acquisition model, but can be otherwise determined. Inputs to the acquisition model can include the prediction model (e.g., current prediction model) and/or any other input. Outputs from the acquisition model can include a sample vector recommendation and/or any other output. For example, the sample vector recommendation can correspond to a prototype sample composition (e.g., formulation, including which ingredients and/or respective proportions) and/or process parameters to test and/or evaluate. The acquisition model can include classical or traditional approaches, machine learning approaches, and/or be otherwise configured. The acquisition model can use one or more of: regression (e.g., linear regression, non-linear regression, logistic regression, etc.), decision tree, LSA, clustering (e.g., k-means clustering, hierarchical clustering, etc.), association rules, dimensionality reduction (e.g., PCA, t-SNE, LDA, etc.), neural networks (e.g., CNN, DNN, CAN, LSTM, RNN, FNN, encoders, decoders, deep learning models, transformers, etc.), ensemble methods, optimization methods (e.g., models used in: multi-objective Bayesian optimization, Bayesian optimal experimental design, any other Bayesian optimization method, etc.), Bayesian acquisition functions, recommender engines, classification, rules, heuristics, equations (e.g., weighted equations, etc.), selection (e.g., from a library), lookups, regularization methods (e.g., ridge regression), Bayesian methods (e.g., Naiive Bayes, Markov), instance-based methods (e.g., nearest neighbor), kernel methods, support vectors (e.g., SVM, SVC, etc.), statistical methods (e.g., probability), comparison methods (e.g., matching, distance metrics, thresholds, etc.), deterministics, genetic programs, and/or any other suitable model. Example acquisition models include: probability of improvement, expected improvement, Bayesian expected losses, upper confidence bounds, Thompson sampling, combinations thereof, and/or any other acquisition model. The models can include (e.g., be constructed using) a set of input layers, output layers, and hidden layers (e.g., connected in series, such as in a feed forward network; connected with a feedback loop between the output and the input, such as in a recurrent neural network; etc.; wherein the layer weights and/or connections can be learned through training); a set of connected convolution layers (e.g., in a CNN); a set of self-attention layers; and/or have any other suitable architecture. Models can be trained, learned, fit, predetermined, and/or can be otherwise determined.

In variants, the sample vector recommendation is a next query point identified via a Bayesian optimization method using the prediction model as the Bayesian optimization surrogate model and the acquisition model as the Bayesian optimization acquisition function. In a first example, the sample vector recommendation is a sample vector that maximizes the acquisition function. In a second example, the sample vector recommendation is a local or global similarity score minima.

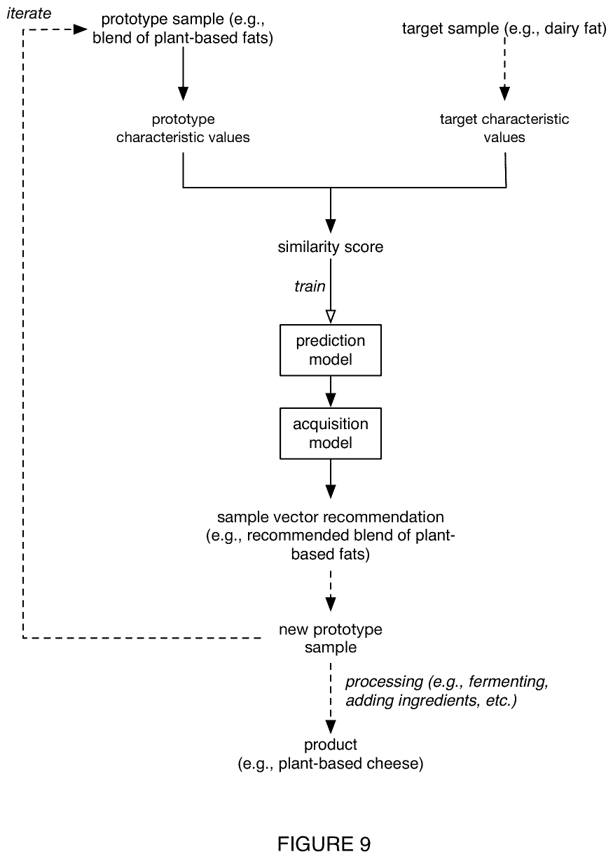

A product can optionally be manufactured based on the sample vector recommendation. An example is shown in FIG. 9. In a first example, an intermediate product can be manufactured based on the sample vector recommendation, and optionally used for additional training data collection (e.g., additional iterations of S100 and S300). In a second example, an end-stage product can be manufactured based on the sample vector recommendation, and optionally used as an analog for a target end-stage product. The product can optionally have one or more characteristic values substantially similar to (e.g., within a predetermined margin of error, such as 1%, 5%, 10%, 20%, 30%, etc.) target characteristic values (e.g., for a target sample). However, any other sample can be manufactured based on the sample vector recommendation

In an illustrative example, determining a new composition (e.g., a sample vector recommendation) for a new prototype sample can include: using an acquisition function to output the new composition based on a prediction model. In an example, the method can include: determining a similarity score (e.g. overall similarity score) for the new prototype sample; and training (e.g., updating, retraining, etc.) the prediction model to predict the similarity score for the new prototype sample based on the new composition. The new prototype cam optionally be manufactured. In a specific example, the method can include: manufacturing the new prototype sample by combining the set of plant-based lipids according to the new composition; adding ingredients to the new prototype sample; and fermenting the new prototype sample to produce a dairy analog food product (e.g., where the prototype sample and the target sample each comprise an unfermented sample).

However, the sample recommendation can be otherwise determined.

As used herein, “substantially” or other words of approximation (e.g., “about,” “approximately,” etc.) can be within a predetermined error threshold or tolerance of a metric, component, or other reference (e.g., within +/−0.001%, +/−0.01%, +/−0.1%, +/−1%, +/−2%, +/−5%, +/−10%, +/−15%, +/−20%, +/−30%, any range or value therein, of a reference).

Different subsystems and/or modules discussed above can be operated and controlled by the same or different entities. In the latter variants, different subsystems can communicate via: APIs (e.g., using API requests and responses, API keys, etc.), requests, and/or other communication channels.

Alternative embodiments implement the above methods and/or processing modules in non-transitory computer-readable media, storing computer-readable instructions that, when executed by a processing system, cause the processing system to perform the method(s) discussed herein. The instructions can be executed by computer-executable components integrated with the computer-readable medium and/or processing system. The computer-readable medium may include any suitable computer readable media such as RAMs, ROMs, flash memory, EEPROMs, optical devices (CD or DVD), hard drives, floppy drives, non-transitory computer readable media, or any suitable device. The computer-executable component can include a computing system and/or processing system (e.g., including one or more collocated or distributed, remote or local processors) connected to the non-transitory computer-readable medium, such as CPUs, GPUs, TPUS, microprocessors, or ASICs, but the instructions can alternatively or additionally be executed by any suitable dedicated hardware device.

Embodiments of the system and/or method can include every combination and permutation of the various system components and the various method processes, wherein one or more instances of the method and/or processes described herein can be performed asynchronously (e.g., sequentially), contemporaneously (e.g., concurrently, in parallel, etc.), or in any other suitable order by and/or using one or more instances of the systems, elements, and/or entities described herein. Components and/or processes of the following system and/or method can be used with, in addition to, in lieu of, or otherwise integrated with all or a portion of the systems and/or methods disclosed in the applications mentioned above, each of which are incorporated in their entirety by this reference.

As a person skilled in the art will recognize from the previous detailed description and from the figures and claims, modifications and changes can be made to the preferred embodiments of the invention without departing from the scope of this invention defined in the following claims.

We claim:

1. A method, comprising:
measuring a target functional property signal for a target sample;
extracting a target functional property feature value from the target functional property signal;
measuring a prototype functional property signal for a prototype sample, wherein the prototype sample is associated with a set of manufacturing variable values;
extracting a prototype functional property feature value from the prototype functional property signal;
training a model based on a comparison between the prototype functional property feature value and target functional property feature value; and
using the trained model, determining a new set of manufacturing variable values for a new prototype sample.

2. The method of claim 1, wherein the manufacturing variable values associated with the prototype sample comprise a vectorized lipid composition for the prototype sample.

3. The method of claim 1, wherein the target functional property feature value comprises a slope of a solid fat content signal for the target sample, wherein the prototype functional property feature value comprises a slope of a solid fat content signal for the prototype sample.

4. The method of claim 3, wherein the slope of the solid fat content signal for the target sample comprises a slope of the solid fat content signal for the target sample between a first temperature of interest and a second temperature of interest, wherein the slope of the solid fat content signal for the prototype sample comprises a slope of the solid fat content signal for the prototype sample between the first temperature of interest and the second temperature of interest, wherein the first temperature of interest is less than 30°, and wherein the second temperature of interest is more than 30°.

5. The method of claim 1, wherein the target functional property feature value comprises a firmness value for the target sample, wherein the prototype functional property feature value comprises a firmness value for the prototype sample.

6. The method of claim 1, further comprising determining a similarity score based on the comparison between the prototype functional property feature values and target functional property feature values, wherein training the model comprises training the model to predict the similarity score based on the manufacturing variable values associated with the prototype sample.

7. The method of claim 6, further comprising:
measuring a second target functional property signal for the target sample;
measuring a second prototype functional property signal for the prototype sample;
determining a processed functional property signal based on the second prototype functional property signal, the second target functional property signal, and a temperature weight function;
determining a second similarity score based on the processed functional property signal; and
determining an overall similarity score by aggregating the similarity score and the second similarity score;
wherein the model is trained to predict the overall similarity score based on the manufacturing variable values associated with the prototype sample.

8. The method of claim 7, wherein determining the processed functional property signal comprises:
determining a combined functional property signal by comparing the second prototype functional property signal to the second target functional property signal; and
determining the processed functional property signal by weighting the combined functional property signal using the temperature weight function.

9. The method of claim 1, wherein the prototype sample comprises a plant-based lipid, and wherein the target sample comprises a dairy lipid.

10. The method of claim 1, further comprising manufacturing the new prototype sample based on the new set of manufacturing variable values.

11. The method of claim 1, wherein the model is trained using Bayesian optimization methods.

12. A method, comprising:
determining a first similarity score based on: a first prototype functional property signal for a prototype sample, a first target functional property signal for a target sample, and a weight function;
determining a second similarity score based on: a second prototype functional property signal for the prototype sample and a second target functional property signal for the target sample;
determining an overall similarity score for the prototype sample by performing a weighted aggregation of the first similarity score and the second similarity score;
training a prediction model to predict the overall similarity score based on a composition of the prototype sample; and
using the prediction model, determining a new composition for a new prototype sample.

13. The method of claim 12, wherein the first prototype functional property signal comprises a reversing heat flow signal, wherein the second prototype functional property signal comprises a texture signal.

14. The method of claim 12, wherein determining the first similarity score comprises:
determining a combined functional property signal by comparing the first prototype functional property signal to the first target functional property signal;
determining a weighted functional property signal by weighting the combined functional property signal using the weight function, wherein the weight function comprises a relationship between weight and temperature; and
determining the first similarity score based on the weighted functional property signal.

15. The method of claim 14, wherein the weight function comprises a zero weight below a first target temperature and above a second target temperature.

16. The method of claim 15, wherein the first target temperature is at least 0° C., and wherein the second target temperature is less than 50° C.

17. The method of claim 12, further comprising determining a third similarity score based on the first prototype functional property signal and the first target functional property signal, wherein the overall similarity score is determined by performing a weighted aggregation of the similarity score, the second similarity score, and the third similarity score.

18. The method of claim 12, wherein the composition of the prototype sample comprises a vectorized composition of multiple plant-based lipids.

19. The method of claim 12, wherein determining the new composition comprises using an acquisition function to output the new composition based on the prediction model, the method further comprising:
determining an overall similarity score for the new prototype sample; and
further training the prediction model to predict the overall similarity score for the new prototype sample based on the new composition.

20. The method of claim 12, wherein the new composition comprises a proportion of each plant-based lipid in a set of plant-based lipids, the method further comprising:
manufacturing the new prototype sample by combining the set of plant-based lipids according to the new composition;
adding ingredients to the new prototype sample; and
fermenting the new prototype sample to produce a dairy analog food product;
wherein the prototype sample and the target sample each comprise an unfermented sample.
